(19) United States
(12) Patent Application Publication
(10) Pub. No.: US 2026/0252797 A1
(43) Pub. Date: Aug. 27, 2026

(54) MODIFYING TIMESTAMP DATA FOR TRANSCRIPT DATA IN AUTOMATIC SPEECH RECOGNITION APPLICATIONS

(71) Applicant: Oracle International Corporation, Redwood Shores, CA (US)

(72) Inventors: Paria Jamshid Lou, Sydney (AU); Hermann Bauerecker, Barcelona (ES); Serge Le Huitouze, Rennes (FR); Ying Xu, Melbourne (AU); Thanh Long Duong, Melbourne (AU)

(73) Assignee: Oracle International Corporation, Redwood Shores, CA (US)

(21) Appl. No.: 19/061,534

(22) Filed: Feb. 24, 2025

(51) Int. Cl. G06F 40/284; G06F 18/241; G06F 40/166

(52) U.S. Cl. CPC G06F 40/284; G06F 18/241; G06F 40/166

(57) ABSTRACT

Techniques are disclosed for modifying timestamp data for transcript data in automatic speech recognition applications. A computing system accesses transcript data that includes token elements. Each token element includes text data and timestamp data associated with an audio recording. The computing system identifies a span of token elements each having a classification label. Based on the classification labels, the computing system determines revised text data and revised timestamp data for the span of token elements. The computing system determines the revised text data based on a combination of text data from each of the token elements, and applies a heuristic rule to determine the revised timestamp data. A modified version of the transcript data, including the revised text data and revised timestamp data, is provided to an additional computing platform configured to perform operations using the modified version of the transcript data.

### BACKGROUND

Automatic speech recognition (ASR) can be used to convert spoken language to written language, such as generating transcript data based on audio input data. In some cases, software applications for performing ASR can be configured to generate time offset values for converted language, such as generating timestamp data for the transcript data. In some cases, timestamp data can indicate start times and end times of recognized spoken words within the audio input data, providing temporal references relative to the beginning (or another time point) in the audio. For example, the timestamp data can indicate when each word was spoken during the audio input data.

In some cases, temporal reference information can provide additional information about audio data that is converted via ASR techniques, such as by providing information about conversation flow, speaker identification, or other characteristics of spoken language in the transcript data. In addition, some contemporary post-processing techniques, such as Inverse Text Normalization (ITN), for generating transcript data can cause inconsistencies or errors in timestamp data associated with the transcript data. Thus, it may be desirable to improve timestamp data for transcript data.

### BRIEF SUMMARY

Techniques disclosed herein relate to ASR applications. In addition, techniques are disclosed herein for modifying timestamp data for transcript data in ASR applications.

In some embodiments, a computer-implemented method includes accessing transcript data comprising a set of token elements. Each token element of the set of token elements comprises text data and timestamp data. The text data represents a portion of a plurality of portions of an audio recording. The timestamp data represents a start time of the portion within the audio recording and an end time of the portion within the audio recording. The computer-implemented method includes generating a modified version of the transcript data that includes revised text data and revised timestamp data. The computer-implemented method includes identifying a set of classification labels for the set of token elements. The computer-implemented method includes identifying a span of token elements within the set of token elements. Each token element in the span of token elements has a respective classification label within the set of classification labels. The computer-implemented method includes, subsequent to identifying a correspondence of the respective classification label for each token element in the span of token elements, determining the revised text data, identifying a heuristic rule, and applying the heuristic rule. The revised text data includes a combination of the text data comprised by each token element in the span of token elements. The heuristic rule is associated with the respective classification label for each token element in the span of token elements. Applying the heuristic rule generates the revised timestamp data based on a combination of the timestamp data comprised by each token element in the span of token elements, wherein the revised timestamp data indicates a revised start time and a revised end time of the combination of the revised text data. The computer-implemented method includes providing the modified version of the transcript data to a computing platform for performing a computing operation using the modified version of the transcript data.

In some embodiments, generating the modified version of the transcript data includes removing, from the transcript data, the text data and the timestamp data comprised by each token element in the span of token elements. In the transcript data, the text data is replaced with the revised text data and the timestamp data is replaced with the revised timestamp data.

In some embodiments, identifying the correspondence of the respective classification label for each token element in the span of token elements includes identifying, in the set of token elements, a first token element and a second token element. The first token element has a first position in the set of token elements and having a first classification label. The second token element has a second position that is subsequent to the first token element in the set of token elements and having a second classification label. The first classification label and the second classification label indicate a first classification type. The span of token elements that includes the first token element and the second token element is identified based on the first classification label and the second classification label indicating the first classification type.

In some embodiments, the second classification label indicates a sequential relationship with the first classification label.

In some embodiments, the sequential relationship is indicated by a flag character included in the second classification label.

In some embodiments, generating the revised timestamp data includes determining first respective timestamp data included in a first token element in the span of token elements and second respective timestamp data included in a second token element in the span of token elements. A heuristic rule library is accessed based on determining that the span of token elements includes the first token element and the second token element. The heuristic rule associated with the respective classification label is identified in the heuristic rule library. Applying the heuristic rule to generate the revised timestamp data includes applying the heuristic rule to the first respective timestamp data and the second respective timestamp data.

In some embodiments, in the transcript data, the text data that represents the portion of the plurality of portions of the audio recording is generated based on automatic speech recognition applied to the audio recording. For each token element in the set of token elements, the start time and the end time are determined based on the automatic speech recognition applied to a converted audio utterance from the portion within the audio recording.

Some embodiments include a system that includes one or more processing systems and one or more computer-readable media storing instructions which, when executed by the one or more processing systems, cause the system to perform part or all of the operations and/or methods disclosed herein.

Some embodiments include one or more non-transitory computer-readable media storing instructions which, when executed by one or more processing systems, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Features, embodiments, and advantages of the present disclosure are better understood when the following Detailed Description is read with reference to the accompanying drawings.

FIG. 1 is a high-level diagram depicting an example of a computing environment that includes capabilities for generating timestamp data for transcript data, according to certain embodiments.

FIG. 2 depicts a simplified architectural diagram of an ASR computing system configured to generate revised timestamp data for transcript data, according to certain embodiments.

FIG. 3 depicts a diagram depicting an example set of one or more data objects that can be utilized to generated revised timestamp data for transcript data, according to certain embodiments.

FIG. 4 depicts a diagram depicting an example set of one or more data objects that include revised timestamp data for transcript data, according to some embodiments.

FIG. 5 depicts an example process flow for generating revised timestamp data for transcript data based on complex combinations of token elements, according to some embodiments.

FIG. 6 is a block diagram illustrating one pattern for implementing a cloud infrastructure as a service system according to certain embodiments.

FIG. 7 is a block diagram illustrating another pattern for implementing a cloud infrastructure as a service system according to certain embodiments.

FIG. 8 is a block diagram illustrating another pattern for implementing a cloud infrastructure as a service system according to certain embodiments.

FIG. 9 is a block diagram illustrating another pattern for implementing a cloud infrastructure as a service system according to certain embodiments.

FIG. 10 is a block diagram illustrating an example computer system according to certain embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

In some cases, a computing system can use ASR techniques to automatically generate transcript data for audio or video that includes audio (e.g., speech or other sounds that are included in or form the audio). Transcript data can include text data that is transcribed (e.g., generated) when speech or other sounds present in the audio or video data is automatically recognized. Transcript data generated via ASR techniques can be used in a variety of use cases. For example, computing systems configured for audio/video editing can use transcript data to generate closed captioning, subtitles, transcriptions (e.g., for broadcast interviews, events, etc.), or to generate other types of text data associated with recorded audio or video data. As an additional example, computing systems configured for data indexing can use transcript data to identify search terms, determine indexable topics (e.g., phrases related to a particular topic, a particular person speaking, etc.), perform named entity recognition, or to perform other techniques for indexing data. Additional computing systems may be configured to use transcript data and associated timestamp data in additional ways.

In some implementations, ASR involves converting speech data (e.g., audio data representing speech) into text data, such as text data transcribed from the speech data. The text data can be included in transcript data, such as transcript data generated by ASR techniques. In addition, ASR can involve performing one or more post-processing techniques, such as post-processing techniques for modifying the text data. In some cases, a post-processing technique involves modifying text data to increase accurate representation of the speech data from which the text data was generated. An example of a post-processing technique to improve accurate representation of speech data is ITN. For example, post-processing techniques for ITN may convert particular types of written data to a specialized format, such as converting a transcribed text phrase “one hundred sixty-three” to “163” based on a specialized written format for a numeric type of written data. In certain approaches, some contemporary post-processing techniques for modifying text data can cause inconsistencies or errors in timestamp data associated with the text data. In the above example, applying a contemporary post-processing technique, such as contemporary ITN, to the phrase “one hundred sixty-three” can cause inconsistencies in timestamp data associated with the modified phrase “163,” such as timestamp data that is missing, incorrectly timed (e.g., indicates an incorrect start time or end time), or otherwise is inconsistent.

Additionally, in some implementations, ASR techniques can include generation of timestamp data that is associated with transcript data for audio data or video data. In addition, timestamp data describes time information for particular portions of the audio or video data, such as a start time and end time for a portion of audio data that includes a particular word, sentence, sound, or other audio portions. In some cases, the timestamp data is associated with respective portions of the transcript data. For example, timestamp data for a portion of audio data that includes a spoken word “hello” is stored with a portion of the transcript data that includes recognized text data (e.g., via ASR) for the spoken word “hello” in the audio data. In some cases, a computing system that is configured to use transcript data may rely on timestamp data that is associated with the transcript data, such as timestamp data that is used to generate an output of the example computing system. As such, it may be desirable to improve the accuracy of timestamp data associated with transcript data and thereby improve outputs of an example computing system. For instance, example computing systems configured for audio/video editing can use improved timestamp data associated with the transcript data to improve the accuracy in matching the generated closed captioning, subtitles, transcriptions, or other text data to actions that occur in corresponding video data, e.g., using timestamp data to match subtitle appearance to motion of an actor's mouth. As an additional example, example computing systems configured for data indexing can use improved timestamp data associated with the transcript data to improve the accuracy in performing data indexing techniques or identifying correlations among indexed data, e.g., using timestamp data to identify correlations among search terms identified from a recorded discussion based on temporal proximity of the search terms within the discussion.

In some cases, generating timestamp data for transcript data that has been modified via an ITN technique can be complex, such as complexities related to linguistic variations, specialized written formats (e.g., dates, times, numbers, units of measurement, etc.), or other types of differences between spoken language and written language. For example, a date that has a written language format of “Aug. 4, 2023” could have multiple different spoken language formats, such as “august fourth twenty twenty three,” “eight four twenty three,” “fourth of august twenty three,” or other variations of spoken language formats. In addition, a spoken language phrase “august fourth twenty twenty three” could have multiple different written language formats, such as “Aug. 4, 2023,” “Aug. 4, 2023,” “08/04/23,” or other variations of written language formats. In this example, contemporary ITN techniques to process each of the variations, e.g., multiple spoken language formats and multiple written language formats, can cause inconsistencies in timestamp data generated for the variations. Examples of timestamp inconsistencies can include omitting timestamp data that should be included in a phrase (e.g., for a phrase “august fourth twenty twenty three,” incorrectly omitting timestamp data for a portion of the phrase “twenty three”), incorrectly identifying divisions between portions of timestamp data (e.g., for a phrase “eight four twenty three,” incorrectly identifying a first portion of timestamp data for “eight” and a second portion of timestamp data “four twenty three”), or other types of inconsistencies in timestamp data. Thus, it may be desirable to determine accurate timestamp data for transcript data that has been modified via ITN or other types of post-processing techniques.

Some contemporary ITN techniques for post-processing transcript data use naive token conversion to generate timestamp data. For example, text data (e.g., generated via ASR) may be identified as including one or more token elements that represent particular portions of the text data. For example, an ITN technique may identify, in the text data, a token element indicating a written language phrase surrounded by whitespace, such as a written word (or other utterance) transcribed via ASR from a spoken word. In addition, the contemporary ITN technique may determine timestamp data for each of the token elements, such as by creating a start time and an end time for each token element. However, naive token conversion that is used by some contemporary ITN techniques may incorrectly generate timestamp data for complicated or representational token elements, such as complex token elements that represent numbers, dates, times, abbreviations, or other types of token elements that represent complex utterances. As an example, an audio recording may include a spoken phrase “H₂O” in the audio data. In this example, transcript data based on the audio data may indicate token elements “H,” “two,” and “O” in the text data. Based on the example transcript data, timestamp data generated using naive token conversion or another contemporary ITN technique may incorrectly generate timestamp data for each of the token elements “H,” “two,” and “O,” such as a first start time and end time pair for “H,” a second start time and end time pair for “two,” and a third start time and end time pair for “O.” Continuing with this example, a computing system that utilizes the transcript data generated by the contemporary ITN technique may provide incorrect output based on the incorrect timestamp data. For instance, a closed captioning computing system may generate incorrect closed captions, such as “H to O” or “H two O” (e.g., instead of “H₂O”). As an additional example, a search indexing computing system may incorrectly identify search terms in the audio recording, such as incorrectly identifying “H” and “O” as separate search terms or failing to correctly identify “H₂O” as a search term.

Therefore, it may be desirable to improve upon contemporary techniques for generating timestamp data by providing a technique for more accurately identifying timestamp data for complex combinations of token elements in transcript data.

The techniques described herein addresses these challenges and others by providing techniques for accurately modifying timestamp data. In addition, techniques are disclosed herein for modifying timestamp data for transcript data in ASR applications. In some cases, the disclosed techniques improve accurate identification (e.g., via ITN or ASR techniques), of multiple token elements that are included in a particular phrase. For example, the disclosed techniques can more accurately (e.g., compared to contemporary ITN techniques) identify combinations of token elements that represent a written or spoken phrase having multiple different formats. In addition, the disclosed techniques can increase accuracy for timestamp data that is generated based on the combinations of token elements, such as providing heuristic rules by which timestamp data can be correctly modified for a particular combination of token elements, as compared to initial timestamp data generated for the individual token elements included in the combination. In some cases, increasing accuracy of the timestamp data can improve outputs of a computing system configured to use transcript data, such as for generating closed captioning, subtitles, transcriptions, or other types of outputs based on transcribed text data or timestamp data.

In various embodiments, a computer-implemented method includes accessing transcript data comprising a set of token elements. Each token element of the set of token elements comprises text data and timestamp data. The text data represents a portion of a plurality of portions of an audio recording. The timestamp data represents a start time of the portion within the audio recording and an end time of the portion within the audio recording. The computer-implemented method includes generating a modified version of the transcript data that includes revised text data and revised timestamp data. The computer-implemented method includes identifying a set of classification labels for the set of token elements. The computer-implemented method includes identifying a span of token elements within the set of token elements. Each token element in the span of token elements has a respective classification label within the set of classification labels. The computer-implemented method includes, subsequent to identifying a correspondence of the respective classification label for each token element in the span of token elements, determining the revised text data, identifying a heuristic rule, and applying the heuristic rule. The revised text data includes a combination of the text data comprised by each token element in the span of token elements. The heuristic rule is associated with the respective classification label for each token element in the span of token elements. Applying the heuristic rule generates the revised timestamp data based on a combination of the timestamp data comprised by each token element in the span of token elements, wherein the revised timestamp data indicates a revised start time and a revised end time of the combination of the revised text data. The computer-implemented method includes providing the modified version of the transcript data to a computing platform for performing a computing operation using the modified version of the transcript data.

### Timestamp Data Generation

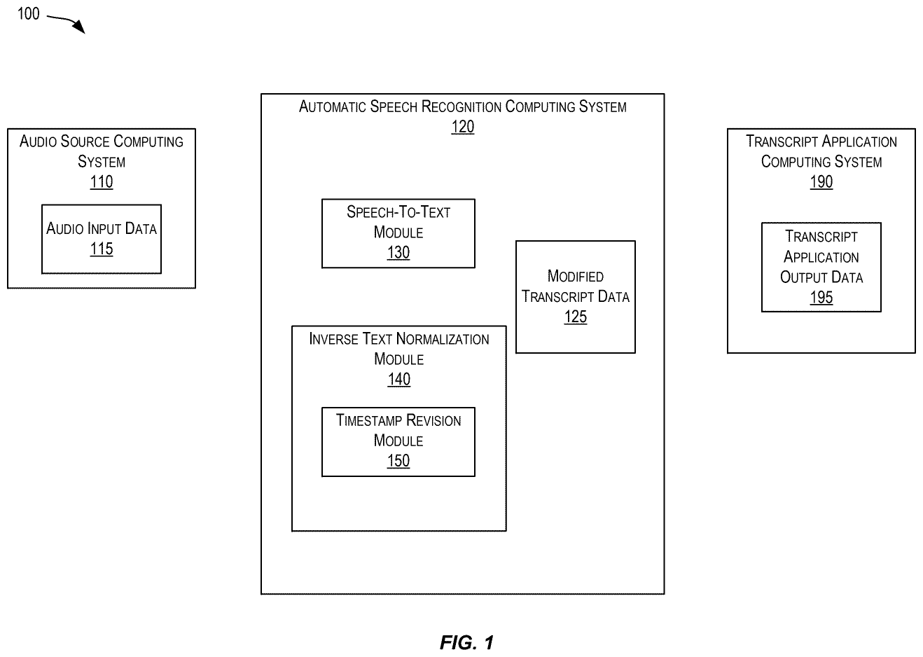

FIG. 1 is an example of a computing environment 100 that includes capabilities for generating timestamp data for transcript data. The computing environment 100 includes an automatic speech recognition computing system 120 (also referred to herein as “ASR computing system 120”), an audio source computing system 110, and a transcript application computing system 190. In FIG. 1, the ASR computing system 120 is configured for generating timestamp data for transcript data. In addition, the ASR computing system 120 includes one or more elements that are configured to improve accuracy of timestamp data generated by the ASR computing system 120. For example, the ASR computing system 120 includes one or more of a speech-to-text module 130, an inverse text normalization module 140 (also referred to herein as “ITN module 140”), and a timestamp revision module 150.

In the computing environment 100, the ASR computing system 120 receives audio data, such as audio input data 115, from the audio source computing system 110. In some cases, the audio source computing system 110 generates the audio input data 115 based on, for example, audio recorded via the audio source computing system 110. For example, the audio source computing system 110 could be configured to generate (or otherwise receive) audio data representing a dialogue between actors in a video, a conversation between a doctor and a patient, a court proceeding (e.g., court reporter recording), or other types of audio data. In some cases, the audio source computing system 110 provides the audio input data 115 to the ASR computing system 120 as continuous (or substantially continuous) data, such as a stream of audio data received by the ASR computing system 120 in real-time. In some cases, the audio source computing system 110 provides the audio input data 115 to the ASR computing system 120 as a discrete data object or group of multiple data objects, such as a prerecorded audio data file. FIG. 1 describes the audio source computing system 110 as being capable of recording audio data, but other implementations are possible. For example, an ASR computing system could receive audio data from an additional audio source computing system configured to store audio data (e.g., a recording library), apply one or more post-processing techniques to audio data (e.g., removing background noise prior to performing automatic speech recognition), or otherwise provide audio data that is not recorded via the additional audio source computing system.

In FIG. 1, the ASR computing system 120 receives the audio input data 115 from the audio source computing system 110. In addition, the ASR computing system 120 provides the audio input data 115 to at least one computing element, such as the speech-to-text module 130. Responsive to receiving the audio input data 115, the speech-to-text module 130 uses the audio input data 115 to generate transcript data for the audio input data 115. In the computing environment 100, the speech-to-text module 130 generates initial transcript data, such as transcript data that is generated via a speech-to-text conversion technique. The initial transcript data from the speech-to-text module 130 includes initial text data representing audio utterances (e.g., audio data of spoken words, audio data of spoken sounds, etc.) that are identified in the audio input data 115. In addition, the speech-to-text module 130 generates initial timestamp data that is associated with the initial text data. In some cases, the initial transcript data from the speech-to-text module 130 is arranged as a sequence (or other arrangement) of token elements that include initial text data and initial timestamp data. For example, a particular token element includes particular text data representing a particular portion of audio data, e.g., a particular portion of the audio input data 115. In the ASR computing system 120, the initial transcript data (e.g., one or more of the initial text data or the initial timestamp data) is generated by the speech-to-text module 130 based on naive token conversion or another technique that omits timestamp data for complex combinations of tokens in the initial transcript data.

In the ASR computing system 120, the ITN module 140 receives, such as from the speech-to-text module 130, one or more of the initial text data or the associated initial timestamp data. Based on the initial text data and the associated initial timestamp data, the ITN module 140 generates revised text data, such as via an inverse text normalization technique. The revised text data from the ITN module 140 includes text data that is revised based on token element spans, e.g., groups of one or more token elements. In some cases, the spans of token elements are identified and normalized by the ITN module 140. Example types of normalization can include numeric, date, time, measurement, abbreviation, or other types of normalization that can be applied to text transcription data. Table 1 includes several examples of potential revised text data that could be generated from token element spans of initial transcript data. Additional examples of normalization types, token element spans, or potential revised text data from token element spans are possible.

TABLE 1

| Normalization Type | Token Element Span | Revised text Data |
|---|---|---|
| Numeric | “one” | “1” |
| Numeric | “four”, “hundred”, “twenty”, | “423” |
| | “three” | |
| Date | “january”, “thirty”, “first” | “January 31” |
| Measurement | “twenty”, “kilograms” | “20 kg” |

In FIG. 1, the ITN module 140 includes (or otherwise is capable of communicating with) the timestamp revision module 150. In addition, the timestamp revision module 150 is configured to access the revised text data generated by the ITN module 140. In some cases, the timestamp revision module 150 is configured to access one or more of the initial text data or the initial timestamp data generated by the speech-to-text module 130. Based on one or more of the revised text data, the initial text data, or the initial timestamp data, the timestamp revision module 150 determines revised timestamp data, such as revised timestamp data associated with the revised text data. In some cases, the timestamp revision module 150 corrects (or otherwise modifies) one or more portions of the initial timestamp data that are inaccurate with respect to the revised text data. In some cases, the revised timestamp data includes corrected (or otherwise modified) portions of timestamp data have improved accuracy with respect to the revised text data. For example, the timestamp revision module 150 can determine a correspondence among one or more token elements that are included in a span, e.g., a token element span identified by the ITN module 140. Responsive to determining the correspondence among the span of token elements, the timestamp revision module 150 can modify portions of timestamp data that are associated with the token elements in the span. For example, the timestamp revision module 150 may determine a correspondence among token elements “january”, “thirty”, and “first” that are included in a particular token element span. Based on the determined correspondence, the timestamp revision module 150 may revise timestamp data associated with the particular token element span. For example, the revision to the timestamp data can include retaining start time data for an initial token element (in this example, “january”) and removing start time data for additional token elements in the particular span (in this example, “thirty” and “first”). In addition, the revision to the timestamp data can include retaining end time data for a final token element (in this example, “first”) and removing end time data for additional token elements in the particular span (in this example, “january” and “thirty”). In some cases, the revised timestamp data is associated with the revised text data (or a portion thereof) from the ITN module 140. Continuing with the example particular token element span, the timestamp revision module 150 (or another component of the computing system 120) can associate the revised timestamp data (e.g., having the start time data for the initial token element “january” and the end time data for the final token element “first”) with a portion of the revised text data that is generated by the ITN module 140 (e.g., a portion of text data including “January 31”).

In the computing environment 100, the ASR computing system 120 generates modified transcript data 125 based on a combination of data outputs from one or more of the speech-to-text module 130, the ITN module 140, or the timestamp revision module 150. For example, the ASR computing system 120 generates the modified transcript data 125 by combining the revised timestamp data generated by the timestamp revision module 150 with the revised text data generated by the ITN module 140. In addition, the ASR computing system 120 can provide the modified transcript data 125 to one or more additional computing systems, such as the transcript application computing system 190. In some cases, the transcript application computing system 190 is configured to generate one or more data outputs based on the modified transcript data 125, such as transcript application output data 195. In some implementations, the transcript application computing system 190 is capable of improving the transcript application output data 195 by using the modified transcript data 125, as compared to utilizing transcript data that lacks complex timestamp data. FIG. 1 describes the computing environment 100 as including a particular transcript application computing system, such as the transcript application computing system 190, but other implementations are possible. For example, an ASR computing system could provide transcript data or modified transcript data to multiple transcript application computing systems, such as a first computing system configured to utilize transcript data for closed captioning generation and a second computing system configured to utilize transcript data for data indexing.

FIG. 1 describes the ASR computing system 120 as including the speech-to-text module 130, the ITN module 140, and the timestamp revision module 150, but other implementations are possible, such as an ASR computing system configured to communicate with at least one additional computing system that can provide data related to automatic speech recognition. For example, an ASR computing system could be configured to communicate with a speech-to-text computing system configured for generating initial transcribed text and/or associated initial timestamp data. As another example, an ASR computing system could be configured to communicate with an inverse text normalization computing system configured for generating revised transcribed text, based on which the example ASR computing system generates revised timestamp data.

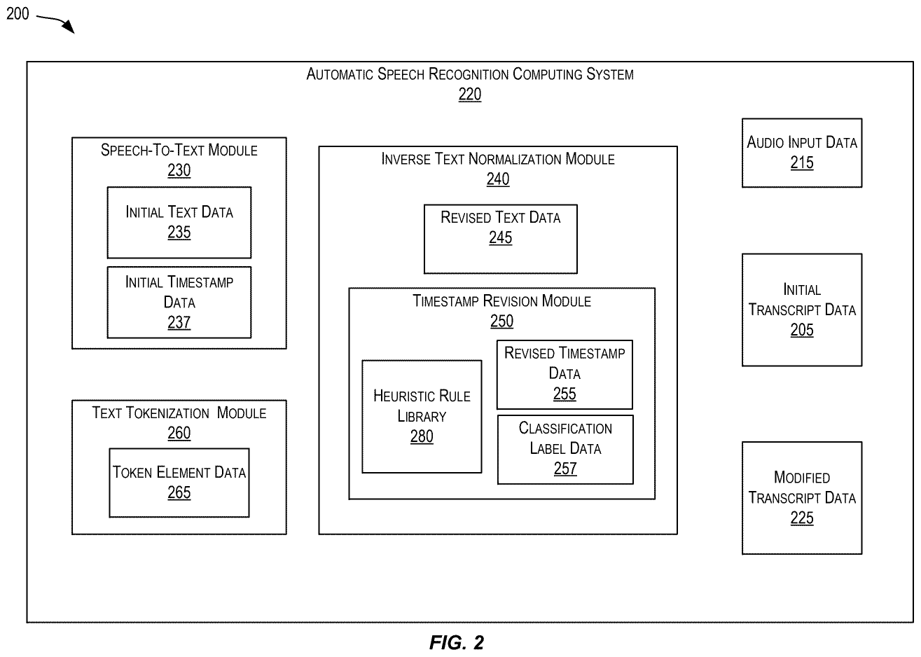

FIG. 2 shows an example of a computing environment 200, in which an ASR computing system 220 is configured to generate revised timestamp data that is associated with transcript data. In some implementations, the ASR computing system 220 generates revised timestamp data that is based on one or more combinations of token data, such as complex combinations of token elements. In FIG. 2, the ASR computing system 220 includes one or more of a speech-to-text module 230, a text tokenization module 260, or an inverse text normalization module 240 (also referred to herein as “ITN module 240”). In some implementations, the ASR computing system 220 is configured to communicate with one or more additional computing systems, such as via one or more computing networks. For example, the ASR computing system 220 could receive data from or otherwise exchange data with at least one computing system configured to provide audio data, such as the audio source computing system 110 described in regard to FIG. 1. As an additional example, the ASR computing system 220 could provide data to or otherwise exchange data with at least one computing system configured to utilize transcript data or associated timestamp data, such as the transcript application computing system 190 described in regard to FIG. 1.

In the computing environment 200, the ASR computing system 220 accesses audio input data 215. In some cases, the ASR computing system 220 receives the audio input data 215 from an additional computing system such as an audio source computing system configured to generate, store, or otherwise provide audio data. In some cases, the ASR computing system 220 generates the audio input data 215, such as via one or more computing subsystems in the ASR computing system 220 that are configured to generate, store, or otherwise provide audio data. In some cases, the ASR computing system 220 accesses the audio input data 215 based on a combination of computing systems. For example, the ASR computing system 220 could receive unprocessed audio data from an audio source computing system and generate the audio input data 215 by applying one or more post-processing techniques (e.g., background noise removal) via a computing subsystem included in the ASR computing system 220.

Based on the audio input data 215, the ASR computing system 220 generates initial transcript data 205. In addition, the initial transcript data 205 can include one or more portions of data, such as one or more of initial text data 235, initial timestamp data 237, or token element data 265. In some cases, one or more subsystems of the ASR computing system 220 generate particular portions of the initial transcript data 205. For example, the speech-to-text module 230 can access the audio input data 215. In addition, the speech-to-text module 230 generates one or more of the initial text data 235 or the initial timestamp data 237 based on the audio input data 215. In some cases, the speech-to-text module 230 can generate the initial text data 235 by applying a speech-to-text technique to convert some or all of the audio input data 215 into text data. In FIG. 2, the initial text data 235 includes text data representing audio utterances that are identified in the audio input data 215. As used herein, “audio utterance” refers to a portion of audio data that indicates a spoken utterance. Examples of spoken utterances can include spoken words, spoken non-word sounds (e.g., “um” interjections, coughing, etc.), or other types of spoken sounds represented by audio data. In addition, the speech-to-text module 230 can generate the initial timestamp data 237 based on the speech-to-text technique, such as by identifying start time and end time pairs associated with respective portions of converted audio data, e.g., respective portions of text data in the initial text data 235. In some implementations, the initial timestamp data 237 is generated based on naive token conversion or another technique that omits complex timestamp data for combinations of audio utterances in the initial text data 235.

In the ASR computing system 220, the text tokenization module 260 can access one or more of the initial text data 235, the initial timestamp data 237, or the audio input data 215 In addition, the text tokenization module 260 generates the token element data 265 based on one or more of the initial text data 235, the initial timestamp data 237, or the audio input data 215. For example, the text tokenization module 260 could generate the token element data 265 by arranging the initial text data 235 or the initial timestamp data 237 as a set (e.g., a sequence or other arrangement) of token elements. In some cases, each particular token element in the set indicates a particular portion of the initial text data 235 and a respective associated portion of the initial timestamp data 237. In some cases, each particular token element in the set corresponds to a particular portion of the audio input data 215, such as a particular audio utterance that is converted by the speech-to-text module 230 into a respective portion of the initial text data 235. FIG. 2 depicts the speech-to-text module 230 and the text tokenization module 260 as particular components (e.g., subsystems) of the ASR computing system 220, but other implementations are possible. For example, an ASR computing system could include a speech-to-text module that is configured to generate token element data, such as in addition to one or more of transcript data or timestamp data.

In FIG. 2, the ASR computing system 220 includes one or more of the initial text data 235, the initial timestamp data 237, or the token element data 265 in the initial transcript data 205. In some implementations, one or more of the ITN module 240 or the timestamp revision module 250 access the initial transcript data 205. In addition, the ASR computing system 220 generates modified transcript data 225 based on data outputs from one or more of the ITN module 240 or the timestamp revision module 250. For example, the ASR computing system 220 includes, in the modified transcript data 225, one or more of revised text data 245 or revised timestamp data 255. Based on the initial text data 235 and the associated initial timestamp data 237, the ITN module 240 generates the revised text data 245, such as via an inverse text normalization technique. The revised text data 245 includes revised text data that is based on spans (or other groups) of one or more token elements, such as token element spans identified and normalized by the ITN module 240. In some cases, the ITN module 240 provides the revised text data 245 as a data output, such as a data output that is included in the modified transcript data 225 (or otherwise accessible by the ASR computing system 220).

In the ASR computing system 220, the timestamp revision module 250 generates the revised timestamp data 255 based on one or more of the revised text data 245, the initial timestamp data 237, or the token element data 265. In addition, the ITN module 240 (or a component thereof, such as the timestamp revision module 250) can classify one or more token elements included in the token element data 265, such as generating classification label data 257 that includes respective classification labels for some or all of the token elements. Based on the respective classification labels, the timestamp revision module 250 can determine a correspondence among one or more token elements that are included in a span. For example, the timestamp revision module 250 may access, in a set of token elements included in the data 265, a span of particular token elements. In addition, the timestamp revision module 250 may determine that each particular token element in the span has respective timestamp data (e.g., a portion of the initial timestamp data 237) and a respective position in an arrangement of the token element data 265, such as sequential positions. In addition, the ITN module 240 or the timestamp revision module 250 generates, for each particular token element in the span, a respective classification label indicating an utterance type for the portions of text (e.g., from the initial text data 235 or the revised text data 245) associated with the particular token element. Examples of classification labels can include NUMBER, DATE, TIME, MEASUREMENT, FRACTION, or other suitable classification labels for types of utterances.

Based on the classification label data 257, the timestamp revision module 250 can identify one or more token spans in the token element data 265, such as span of token elements having respective classification labels that each indicate a particular utterance type. For example, the timestamp revision module 250 identifies a particular token span based on a determination that each token element in the particular span has a DATE classification label, e.g., indicating the token elements correspond to utterances involving calendar date information. In some cases, the timestamp revision module 250 can identify one or more token spans based on one or more flagged classification labels, such as flagged classification labels indicating a sequence arrangement of the token elements in the particular span. For example, the timestamp revision module 250 generates flag data for some or all of the classification labels for the particular span of token elements. In some cases, the flag data indicates a position of one or more of the token elements with respect to other token elements in the particular span. For example, if the particular span of token elements is arranged as a sequence, an initial token element could have a classification label with flag data indicating an initial position in the span and additional token elements could have additional classification labels with additional flag data indicating subsequent positions in the span. In some cases, the timestamp revision module 250 identifies the particular token span based on a determination that one or more of the token elements in the particular span has a flagged DATE classification label. In the example of the DATE classification label, a first token element in the particular span could have a first classification label “DATE” in which an absence of a flag indicates a first position (such as, but not limited to, an initial position) in the sequence arrangement of the particular span. Continuing with the example DATE classification label, a second token element in the particular span could have a second classification label “_DATE” in which a flag character “_” indicates a second position (such as, but not limited to, a subsequent position) in the sequence arrangement of the particular span. In FIG. 2, the timestamp revision module 250 is described as determining two types of flag data, e.g., an absence of a flag indicating an initial position and a flag character “_” indicating a subsequent (e.g., non-initial) position, but other implementations are possible, such as a timestamp revision module that is configured to determine initial position flag data, terminal position flag data (e.g., indicating a final position in a sequence), interim position flag data (e.g., indicating one or more positions between an initial position and a terminal position in a sequence), or other types of flag data. Examples of flag data can include an alphanumeric character, a Boolean data type, an absence of additional data (e.g., flagged labels compared to unflagged labels), or other types of data suitable to flag a classification label.

In FIG. 2, the timestamp revision module 250 determines the revised timestamp data 255 based on the classification label data 257, such as a combination of the classification label data 257 with one or more of the initial text data 235, the initial timestamp data 237, or the token element data 265. For example, the timestamp revision module 250 identifies, based on the classification label data 257, a token span that includes multiple token elements having classification labels indicating a particular utterance type, such as the example token span having the DATE classification label.

In addition, the timestamp revision module 250 generates a portion of the revised timestamp data 255 based on the identified token span. For example, based on the flagged classification labels associated with the identified token span, the timestamp revision module 250 identifies a first token element having an initial position in the token span and a second token element having a terminal position in the token span. In addition, the timestamp revision module 250 determines a start time of the first token element and an end time of the second token element. Based on the determined start time and end time, the timestamp revision module 250 generates a revised timestamp pair that corresponds to the identified token span. In addition, the timestamp revision module 250 includes the revised timestamp pair in the revised timestamp data 255. In some cases, the revised timestamp pair corresponds to a portion of the revised text data 245, such as particular revised text data determined by the ITN module 240 for the token elements included in the identified token span. In some cases, the timestamp revision module 250 may omit or remove interim timespan data from the revised timestamp pair, such as omitting an end time of the first token element, a start time of the second token element, or additional start or end times of additional token elements in the token span (e.g., having interim positions between the first and second token elements).

In some cases, the timestamp revision module 250 can identify one or more heuristic rule techniques to generate the portion of the revised timestamp data 255, such as identifying a particular heuristic rule based on one or more characteristics of the identified token span. For example, the timestamp revision module 250 could include (or otherwise access) a heuristic rule library 280. FIG. 2 depicts the heuristic rule library 280 as being included in the ASR computing system 220, but other implementations are possible, such as a heuristic rule library included in an additional computing system or component, which is accessible by a timestamp revision module or an ASR computing system. The heuristic rule library 280 could include multiple heuristic rule techniques associated with one or more characteristics of token elements or spans of token elements, such as a classification label characteristic. In some cases, the timestamp revision module 250 (or another component of the ASR computing system 220) identifies a heuristic rule that is associated with a particular classification label. For example, based on a determination that each token element in an identified token span has a particular classification label, e.g., the example token span having the DATE classification label, the timestamp revision module 250 identifies one or more heuristic rules associated with the particular classification label, e.g., a heuristic rule for the DATE classification label. In addition, the timestamp revision module 250 applies the identified heuristic rule to the identified token span to generate the associated portion of the revised timestamp data 255.

In some cases, the ASR computing system 220 can determine the revised timestamp data 255 with improved accuracy using heuristic rules, such as improved accuracy as compared to manual efforts to revise timestamp data. For example, the timestamp revision module 250 can use the heuristic rule library 280 to resolve (e.g., accurately generate revised timestamp data for) multiple varieties of complex token combinations that are identified in the token element data 265. Examples of complex token combinations can include one-to-one combinations (e.g., initial timestamp data for one token element is resolved to revised timestamp data for one token element), many-to-one combinations (e.g., initial timestamp data for multiple token elements is resolved to revised timestamp data for one token element), many-to-many combinations (e.g., initial timestamp data for multiple token elements is resolved to revised timestamp data for multiple token elements), or other complex combinations of token elements.

In some cases, characteristics of transcript data associated with one or more token elements can increase complexity for a token span. For example, token spans can have initial transcript data that includes one or more variations in audio utterances for describing similar types of utterances, such as “quarter until two,” “quarter to two,” “quarter before two,” or other variations in audio utterances to describe a particular time of day. In some cases, the timestamp revision module 250 can use various heuristic rules from the heuristic rule library 280 to accurately generate revised timestamp data for various complex token combinations that are identified in the token element data 265. In the ASR computing system 220, the timestamp revision module 250 determines a revised timestamp pair for each token span that is identified based on the classification label data 257. In addition, the timestamp revision module 250 generates respective portions of the revised timestamp data 255 for each revised timestamp pair. In some cases, the ITN module 240, the timestamp revision module 250, or another component of the ASR computing system 220 generates the modified transcript data 225 based on one or more of the revised text data 245 or the revised timestamp data 255. For example, the ITN module 240 could modify the modified transcript data 225 to include the revised text data 245 and the timestamp revision module 250 could modify the modified transcript data 225 to include the revised timestamp data 255. In some cases, the modified transcript data 225 could include the classification label data 257. In some implementations, the ASR computing system 220 provides some or all of the modified transcript data 225 to at least one additional computing system, such as the transcript application computing system 190 described in regard to FIG. 1. Based on the modified transcript data 225, the additional computing system generates one or more data outputs, such as closed captioning data, subtitle data, indexing data, or other types of data outputs that are based on transcript data.

In some cases, the timestamp revision module 250 accesses the revised text data 245 subsequent to the ITN module 240, such as accessing the revised text data 245 as a data output from the ITN module 240. In some cases, the timestamp revision module 250 accesses the revised text data 245 concurrently (or substantially concurrently) with the ITN module 240, such as accessing portions of the revised text data 245 as the portions are generated by the ITN module 240. In some implementations, the ITN module 240 generates the revised text data 245 based (at least in part) on one or more classification labels generated by the timestamp revision module 250 for token elements, e.g., classification labels that are generated concurrently (or substantially concurrently) as an inverse text normalization technique applied to the token elements by the ITN module 240. FIG. 2 depicts the ITN module 240 as including the timestamp revision module 250, but other implementations are possible. For example, an ASR computing system could include an ITN module and a timestamp revision module as separate elements (e.g., subsystems).

Examples of heuristic rule techniques can include exact-match rules, span-specific rules, date-span rules, measurement-span rules, time-span rules, fraction-span rules, or additional types of rule-based techniques for additional types of spans. In some cases, the heuristic rule library 280 could include one or more heuristic rule techniques based on the examples described herein.

As an example, an exact-match heuristic rule technique can include searching for exact matches between initial text data and revised text data. In some cases, a token span that includes only one token element is identified as an exact match. If exact matches are found, the corresponding initial timestamp data (e.g., start and end time pair) is used to generate the revised timestamp data. In some cases, an exact-match heuristic rule technique can include annotating (or otherwise indicating) the matched initial text data and revised text data, such as an annotation to prevent reuse of the corresponding initial timestamp data or revised timestamp data in another portion of revised timestamp data (e.g., preventing overlapping start/end time pairs among multiple revised timestamp data portions). In some cases, an exact-match heuristic rule technique is performed prior to additional heuristic rule techniques, such as to generate revised timestamp data for single-token transcript data (e.g., initial or revised text data that does not include complex combinations of token elements) prior to generating revised timestamp data for complex combinations of token elements.

As another example, a span-specific heuristic rule technique can include identifying a token element or a span of token elements that is not identified by (or otherwise is omitted from) a search for exact-match token elements, such as a search performed during an exact-match heuristic rule technique. In some cases, a span-specific heuristic rule technique is performed subsequent to performing an exact-match heuristic rule technique. For example, if there is one (e.g., only one) span of token elements remaining subsequent to performing an exact-match heuristic rule technique, then revised timestamp data for the remaining span of token elements is generated based on a start time for an initial token element in the remaining span and an end time for an initial token element in the remaining span.

In some cases, if a span-specific heuristic rule technique identifies multiple token elements or spans of token elements that are not identified by (or otherwise are omitted from) a search for exact-match token elements, one or more class-based heuristic rule techniques can be applied. In some cases, a class-based heuristic rule techniques can be identified and/or applied based on classification label data that is associated with a token element or span of token elements. For example, the timestamp revision module 250 could identify one or more class-based heuristic rule techniques based on one or more portions of the classification label data 257.

Examples of class-based heuristic rule techniques can include date-span rule techniques, measurement-span rule techniques, time-span rule techniques, fraction-span rule techniques, or additional types of class-based heuristic rule techniques for additional types of classification labels. In addition, these example class-based heuristic rule techniques can be respectively associated with classification labels such as DATE, MEASUREMENT, TIME, FRACTION, or other suitable classification labels.

As an example, a date-span heuristic rule technique can include identifying one or more portions of a token element span with a DATE classification label. In the DATE-classified span, identified portions can include respective token elements associated with initial or revised text data describing a month, a day, or a year. For example, responsive to identifying a token element associated with text data describing a month (e.g., “12”, “December”, “Dec.”), the corresponding initial timestamp data (e.g., start and end time pair) is used to generate the revised timestamp data for the DATE-classified span. In addition, responsive to identifying another token element associated with text data describing a day (e.g., “second”, “2”, “2nd”), the corresponding initial timestamp data is further used to generate the revised timestamp data for the DATE-classified span. In some cases, the text data describing the day is identified as a ordinal (e.g., “second”, “2nd”) or cardinal (e.g., “two”, “2”) date format, and the revised timestamp data is generated based on the identified date format. In addition, responsive to identifying another token element associated with text data describing a year (e.g., “2002”, “twenty oh two”), the corresponding initial timestamp data is further used to generate the revised timestamp data for the DATE-classified span. In some cases, one or more token elements in the DATE-classified span include text data describing interim words, such as text data “of” included in text data describing a phrase “second of September.” In addition, responsive to identifying a token element associated with text data describing an interim word, the corresponding initial timestamp data is further used to generate the revised timestamp data for the DATE-classified span.

As another example, a measurement-span heuristic rule technique can include identifying one or more portions of a token element span with a MEASUREMENT classification label. In the MEASUREMENT-classified span, identified portions can include respective token elements associated with initial or revised text data describing a numeric value, a separator, or a unit of measurement. For example, the MEASUREMENT-classified span is determined to include or omit a token element associated with text data describing a separator (e.g., “per”, “slash”, “a”, “each”). An example of a separator in a MEASUREMENT-classified span could be text data “an” included in text data describing a phrase “fifty milligrams an hour.” An example of a MEASUREMENT-classified span that omits a separator could be text data describing a phrase “forty three millimeters mercury.”

Responsive to determining that the MEASUREMENT-classified span includes a token element associated with text data describing a separator, remaining token elements in the span are identified as preceding or following the token element describing the separator. In this example, a token element immediately preceding the token element describing the separator is identified as describing a first unit of measurement, such as a token element describing “milligram” in the example phrase “fifty milligrams an hour.” In addition, a token element immediately following the token element describing the separator is identified as describing a second unit of measurement, such as a token element describing “hour” in the example phrase “fifty milligrams an hour.” Further, one or more token elements preceding the token element describing the first unit of measurement are identified as describing numeric values, such as a token element describing “fifty” in the example phrase “fifty milligrams an hour.” In this example, responsive to identifying the token element describing the numeric value (e.g., “fifty”), the corresponding initial timestamp data (e.g., start and end time pair) is used to generate a first portion of the revised timestamp data for the MEASUREMENT-classified span, such as a start time and end time associated with “fifty” in the example phrase “fifty milligrams an hour.” In addition, responsive to identifying the token elements describing the separator, first unit of measurement, and second unit of measurement, the corresponding initial timestamp data is used to generate a second portion of the revised timestamp data for the MEASUREMENT-classified span, such as a start time associated with “milligrams” and an end time associated with “hour” in the example phrase “fifty milligrams an hour.”

Responsive to determining that the MEASUREMENT-classified span omits (e.g., does not include) a token element associated with text data describing a separator, the token elements in the span are identified as describing or excluding numeric values. In some cases, the token elements in the span are evaluated in a reverse order (e.g., a final token element in a span is evaluated initially). In the example phrase “forty three millimeters mercury,” respective token elements describing “mercury” and “millimeters” are identified as excluding (e.g., not describing) numeric values. In addition, a token element describing “three” is identified as describing a numeric value. In this example, any remaining token elements preceding the token element describing “three” (e.g., remaining token elements not yet evaluated in the reverse order) are identified as describing additional numeric values, such as the token element describing “forty” in the example phrase “forty three millimeters mercury.” In this example, responsive to identifying the token elements describing the numeric values (e.g., “three” and “forty”), the corresponding initial timestamp data is used to generate a first portion of the revised timestamp data for the MEASUREMENT-classified span, such as a start time associated with “forty” and an end time associated with “three” in the example phrase “forty three millimeters mercury.” In addition, responsive to identifying the token elements identified as excluding numeric values (e.g., “mercury” and “millimeters”), the corresponding initial timestamp data is used to generate a second portion of the revised timestamp data for the MEASUREMENT-classified span, such as a start time associated with “millimeters” and an end time associated with “mercury” in the example phrase “forty three millimeters mercury.”

In some cases, the MEASUREMENT-classified span could be determined to include multiple token elements associated with text data describing multiple separators and multiple units of measurement. An example of multiple separators in a MEASUREMENT-classified span could be text data “each” and “per” included in text data describing a phrase “five milligrams each day per pound.” An example of multiple units of measurement in a MEASUREMENT-classified span could be text data “milligrams”, “day”, and “pound” included in text data describing the phrase “five milligrams each day per pound.” In some cases, initial timestamp data for all identified separators and units of measurement is used to generate revised timestamp data, such as a start time associated with “milligrams” and an end time associated with “pound” in the example phrase “five milligrams each day per pound.”

As another example, a time-span heuristic rule technique can include identifying one or more portions of a token element span with a TIME classification label. In the TIME-classified span, identified portions can include respective token elements associated with initial or revised text data describing a numeric value or a time suffix. For example, responsive to identifying a token element associated with text data describing a time suffix (e.g., “oclock”, “pm”, “gmt”), the corresponding initial timestamp data (e.g., start and end time pair) is used to generate a first portion of the revised timestamp data for the TIME-classified span, such as a start time associated with “pm” and an end time associated with “t” in the example phrase “quarter past two pm gmt.” In this example, the first portion of the revised timestamp data is described as including revised timestamp data for token elements associated with “pm” and “gmt” but other implementations are possible. For example, a first time suffix (e.g., “pm”) could have first revised time data and a second time suffix (e.g., “gmt”) could have second revised time data. In addition, one or more token elements in the TIME-classified span are identified as being associated with text data describing a numeric value. For example, responsive to identifying a token element associated with text data describing a numeric value (e.g., “quarter”, “past”, “two”), the corresponding initial timestamp data is used to generate a second portion of the revised timestamp data for the TIME-classified span, such as a start time associated with “quarter” and an end time associated with “two” in the example phrase “quarter past two pm gmt.”

As another example, a fraction-span heuristic rule technique can include identifying one or more portions of a token element span with a FRACTION classification label. In the FRACTION-classified span, identified portions can include respective token elements associated with initial or revised text data describing an integer, a numerator, or a denominator. For example, responsive to identifying a token element associated with text data describing an integer (e.g., “twenty”, “one”), the corresponding initial timestamp data (e.g., start and end time pair) is used to generate a first portion of the revised timestamp data for the FRACTION-classified span. As an example, the first portion of the revised timestamp data could include a start time associated with “twenty” and an end time associated with “one” in the example phrase “twenty one and two thirds.” In addition, responsive to identifying additional token elements respectively associated with text data describing a numerator and a denominator, the corresponding initial timestamp data is used to generate a second portion of the revised timestamp data for the FRACTION-classified span, such as a start time associated with “two” and an end time associated with “thirds” in the example phrase “twenty one and two thirds.”

In some cases, identified portions of a FRACTION-classified span can include one or more token elements associated with initial or revised text data describing one or more interim words, such as a token element associated with “and” in the example phrase “twenty one and two thirds.” In addition, the corresponding initial timestamp data of the token element for the interim word could be included in a particular one of the first or second (or additional) portions of the revised timestamp data. Continuing with the example phrase “twenty one and two thirds,” initial timestamp data associated with “an” could be included in the second portion of the revised timestamp data, such as a start time associated with “and” and an end time associated with “thirds” in the example phrase. However, other implementations are possible, such as using initial timestamp data for one or more interim words in revised timestamp data for an integer, or omitting initial timestamp data for one or more interim words from revised timestamp data.

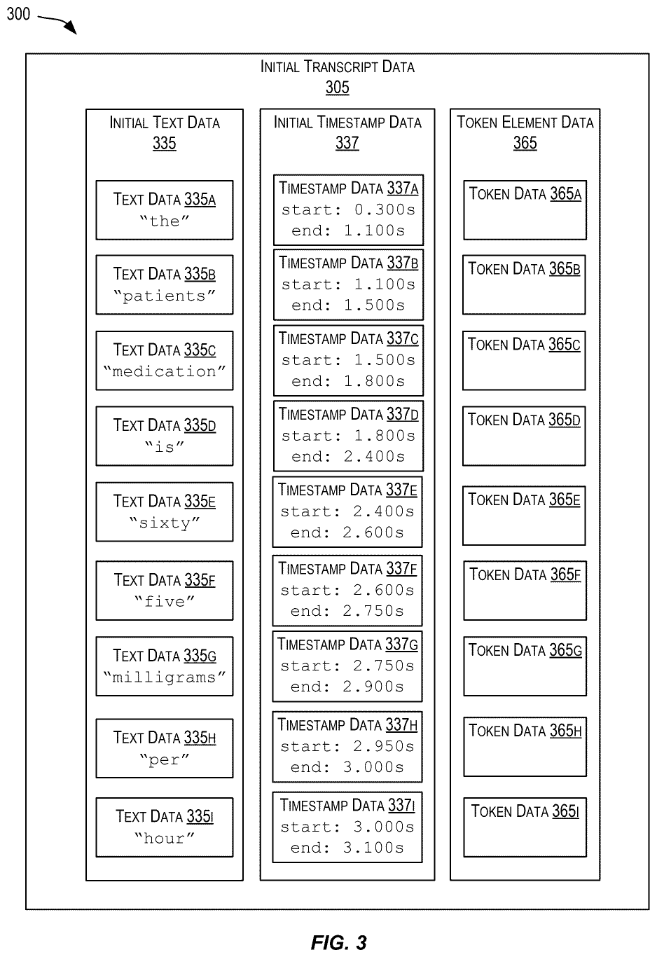

FIG. 3 is a diagram depicting an example set of one or more data objects, such as a computing data object set 300, that can be utilized to generated revised timestamp data for transcript data. The computing data object set 300 can include one or more data objects, such as initial transcript data 305, initial text data 335, initial timestamp data 337, or token element data 365. In some cases, one or more of the data objects in the computing data object set 300 is generated or modified by one or more components of an ASR computing system, such as the ASR computing system 220. For example, the initial transcript data 305 can be generated by the ASR computing system 220, such as included in, or in addition to, the initial transcript data 205. In addition, one or more of the initial text data 335 or the initial timestamp data 337 can be generated by the speech-to-text module 230, such as included in, or in addition to, the initial text data 235 or the initial timestamp data 237. Furthermore, the token element data 365 can be generated by the text tokenization module 260, such as included in, or in addition to, the token element data 265. In FIG. 3, one or more of the initial transcript data 305, the initial text data 335, the initial timestamp data 337, or the token element data 365 are computer-implemented data objects that can be utilized by an ASR computing system or components included therein, such as a speech-to-text module, a text tokenization module, an ITN module, or a timestamp revision module. Examples of computer-implemented data objects for the data 305, 335, 337, or 365 can include data arrays, data lists, database entries, or other types of suitable data objects.

In FIG. 3, the initial text data 335 includes multiple portions of text data, including text data 335a, text data 335b, text data 335c, text data 335d, text data 335e, text data 335f, text data 335g, text data 335h, and text data 335i. Each of the portions of text data 335a-335i includes text representing a respective portion of input audio data, such as a respective audio utterance converted from an audio recording. For example, each of the text data 335a-335i respectively includes text representing portions of audio data for converted audio utterances “the”, “patients”, “medication”, “is”, “sixty”, “five”, “milligrams”, “per”, “hour”. In FIG. 3, the portions of the text data 335a-335i are arranged in the initial text data 335 as a sequence, e.g., a sequence arrangement of text data portions corresponding to a sequence of the converted audio utterances as arranged in audio input data.

In FIG. 3, the initial timestamp data 337 includes multiple portions of timestamp data, including timestamp data 337a, timestamp data 337b, timestamp data 337c, timestamp data 337d, timestamp data 337e, timestamp data 337f, timestamp data 337g, timestamp data 337h, and timestamp data 337i. Each of the portions of timestamp data 337a-337i includes a start time and end time pair associated with a respective one of the converted audio utterances. For example, each of the timestamp data 337a-337i respectively includes a start time and end time pair associated with a respective one of the converted audio utterances “the”, “patients”, “medication”, “is”, “sixty”, “five”, “milligrams”, “per”, “hour”. In FIG. 3, the portions of the timestamp data 337a-337i are arranged in the initial timestamp data 337 as a sequence, e.g., a sequence arrangement of timestamp data portions corresponding to a sequence of the converted audio utterances as arranged in audio input data.

In FIG. 3, the token element data 365 includes multiple portions of token data, including token data 365a, token data 365b, token data 365c, token data 365d, token data 365e, token data 365f, token data 365g, token data 365h, and token data 365i. Each of the portions of token data 365a-365i includes a token element associated with a respective one of the converted audio utterances. For example, each of the token data 365a-365i respectively includes a token element associated with a respective one of the converted audio utterances “the”, “patients”, “medication”, “is”, “sixty”, “five”, “milligrams”, “per”, “hour”. In FIG. 3, the portions of the token data 365a-365i are arranged in the token element data 365 as a sequence, e.g., a sequence arrangement of token data portions corresponding to a sequence of the converted audio utterances as arranged in audio input data.

In FIG. 3, the initial transcript data 305 indicates associations among particular portions of text data, timestamp data, and token data that correspond to a particular converted audio utterance. For example, the initial transcript data 305 indicates an association of the portion of text data 335a, the portion of timestamp data 337a, and the portion of token data 365a, based on the correspondence of the particular converted audio utterance “the” with the data portions 335a, 337a, and 365a.

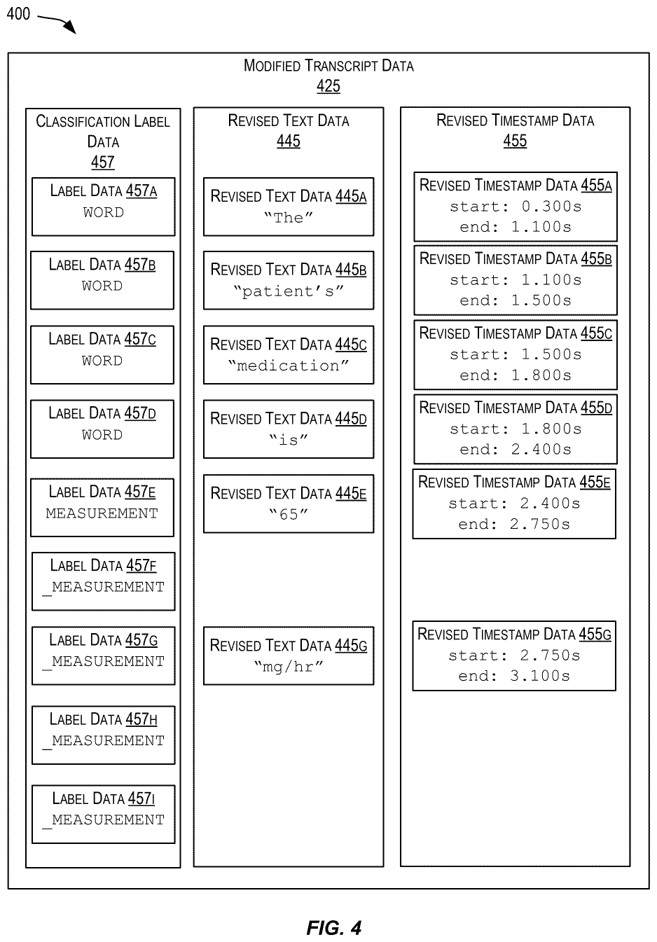

FIG. 4 is a diagram depicting an example set of one or more data objects, such as a computing data object set 400, that can include revised timestamp data for transcript data. The computing data object set 400 can include one or more data objects, such as modified transcript data 425, classification label data 457, revised text data 445, or revised timestamp data 455. In some cases, one or more of the data objects in the computing data object set 400 is generated or modified by one or more components of an ASR computing system, such as the ASR computing system 220. For example, the modified transcript data 425 can be generated by the ASR computing system 220, such as included in, or in addition to, the modified transcript data 225. In addition, the revised text data 445 can be generated by the ITN module 240, such as included in, or in addition to, the revised text data 245. Furthermore, one or more of the classification label data 457 or the revised timestamp data 455 can be generated by the ITN module 240 (or another component of the ASR computing system 220, such as the timestamp revision module 250), such as included in, or in addition to, the classification label data 257 or the revised timestamp data 255. In FIG. 4, one or more of the modified transcript data 425, the classification label data 457, the revised text data 445, or the revised timestamp data 455 are computer-implemented data objects that can be utilized by an ASR computing system or components included therein, such as a speech-to-text module, a text tokenization module, an ITN module, or a timestamp revision module. Examples of computer-implemented data objects for the data 425, 457, 445, or 455 can include data arrays, data lists, database entries, or other types of suitable data objects.

In some cases, one or more of the data objects in the computing data object set 400 are generated or modified based on one or more of the data objects in the computing data object set 300. For example, the ITN module 240 could generate the revised text data 445 based on (at least) the initial text data 335. As an additional example, the timestamp revision module 250 could generate one or more of the classification label data 457 or the revised timestamp data 455 based on (at least) one or more of the initial timestamp data 337 or the token element data 365. FIG. 4 depicts the modified transcript data 425 as including the classification label data 457, but other implementations are possible.

In FIG. 4, the classification label data 457 includes multiple portions of classification label data, including label data 457a, label data 457b, label data 457c, label data 457d, label data 457e, label data 457f, label data 457g, label data 457h, and label data 457i. Each of the portions of label data 457a-457i includes a classification label indicating a respective utterance type for an associated token element, such as a particular token element in the token data 365a-365i. For example, each of the portions of label data 457a, 457b, 457c, and 457d could include a first classification label indicating a first utterance type for, respectively, the portions of token data 365a, 365b, 365c, and 365d or the associated portions of text data 335a, 335b, 335c, and 335d. In this example, the first classification label could indicate “WORD” as the first utterance type, such as for the converted audio utterances “the”, “patients”, “medication”, and “is”. As an additional example, each of the portions of label data 457e, 457f, 457g, 457h, and 457i could include a second classification label indicating a second utterance type for, respectively, the portions of token data 365e, 365f, 365g, 365h, and 365i or the associated portions of text data 335e, 335f, 335g, 335h, and 335i. In this example, the second classification label could indicate “MEASUREMENT” as the second utterance type, such as for the converted audio utterances “sixty”, “five”, “milligrams”, “per”, and “hour”.

In FIG. 4, the portions of the label data 457a-457i are arranged in the classification label data 457 as a sequence, e.g., a sequence arrangement of label data portions corresponding to a sequence of the token element data 365 (or other data objects in the computing data object set 300). In some cases, one or more of the portions of label data 457a-457i could include flag data, such as flag data (e.g., a flag character “_”) indicating a subsequent position in a sequence arrangement. For example, the label data 457e could include the second classification label (“MEASUREMENT”) and the label data 457f, 457g, 457h, and 457i could include a combination of flag data with the second classification label (e.g., “_MEASUREMENT”). In some cases, some portions of the classification label data 457 omit flag data. For instance, the portions of label data 457a, 457b, 457c, and 457d could include the first classification label and omit flag data. In some implementations, a particular type of flag data or omission of flag data can indicate, e.g., to the timestamp revision module 250, that associated portions of text data have unmodified timestamp data. For example, based on a determination that the first classification label “WORD” omits flag data, the timestamp revision module 250 could determine that the associated portions of text data 335a, 335b, 335c, and 335d have unmodified portions of timestamp data 337a, 337b, 337c, and 337d.

In FIG. 4, the revised text data 445 includes multiple portions of revised text data, including revised text data 445a, revised text data 445b, revised text data 445c, revised text data 445d, revised text data 445e, and revised text data 445g. Each of the portions of revised text data 445a-445e and 445g includes revised text corresponding to at least one portion of the initial text data 335, such as revised text that is based on a normalization technique applied by the ITN module 240. For example, the portions of revised text data 445a, 445b, 445c, and 445d could include revised text “The”, “patient's”, “medication”, and “is” that correspond to, respectively, the converted audio utterances “the”, “patients”, “medication”, and “is” represented by the portions of text data 335a, 335b, 335c, and 335d. In addition, the portion of revised text data 445e could include revised text “65” that corresponds to a combination of the converted audio utterances “sixty” and “five” represented by the portions of text data 335e, and 335f. Furthermore, the portion of revised text data 445g could include revised text “mg/hr” that corresponds to a combination of the converted audio utterances “milligrams”, “per”, and “hour” represented by the portions of text data 335g, 335h, and 335i. In some cases, a particular portion of revised text in the revised text data 445 can be associated with one or more token elements, such as in the token element data 365.

In FIG. 4, the revised timestamp data 455 includes multiple portions of revised timestamp data, including revised timestamp data 455a, revised timestamp data 455b, revised timestamp data 455c, revised timestamp data 455d, revised timestamp data 455e, and revised timestamp data 455g. Each of the portions of revised timestamp data 455a-455e and 455g includes a revised start time and revised end time pair corresponding to at least one portion of the initial timestamp data 337. In some cases, the timestamp revision module 250 determines the revised timestamp data 455 based on the classification label data 457, such as by identifying one or more token spans based on the classification label data 457. For example, based on the portions of label data 457a, 457b, 457c, and 457d (e.g., including the first classification label “WORD” and omitting flag data), the timestamp revision module 250 can determine that the portions of revised timestamp data 455a, 455b, 455c, and 455d include revised start time and revised end time pairs that are unmodified from the respective portions of timestamp data 337a, 337b, 337c, and 337d. In addition, based on the portions of label data 457e and 457f (e.g., including the second classification label “MEASUREMENT” and flag data), the timestamp revision module 250 can determine that the portion of revised timestamp data 455e includes a revised start time and revised end time pair that is based on a combination of the respective portions of timestamp data 337e and 337f (e.g., a start time of timestamp data 337e and an end time of timestamp data 337f). Furthermore, based on the portions of label data 457g, 457h, and 457i (e.g., including the second classification label “MEASUREMENT” and flag data), the timestamp revision module 250 can determine that the portion of revised timestamp data 455g includes a revised start time and revised end time pair that is based on a combination of the respective portions of timestamp data 337g, 337h, and 337i (e.g., a start time of timestamp data 337g and an end time of timestamp data 337i).

In some cases, one or more portions of the modified transcript data 425, such as the revised timestamp data 455, is generated based on one or more heuristic rules, such as heuristic rules identified based on the classification label data 457. For example, the timestamp revision module 250 can identify a heuristic rule associated with the second classification label “MEASUREMENT”. In addition, the timestamp revision module 250 can generate the revised timestamp data 455e or 455g by applying the identified heuristic rule to one or more of the timestamp data 337e-337i, the text data 335e-335i, the revised text data 445e or 445g, or a combination thereof. For example, the timestamp revision module 250 can generate the revised timestamp data 455e by determining, based on the identified heuristic rule, that the timestamp data 337e-337f, the text data 335e-335f, and the revised text data 445e correspond to a first portion of a measurement (e.g., a numeric portion). Continuing this example, the timestamp revision module 250 can generate the revised timestamp data 455g by determining, based on the identified heuristic rule, that the timestamp data 337g-337i, the text data 335g-335i, the revised text data 445g correspond to a second portion of a measurement (e.g., a unit portion). In some cases, the timestamp revision module 250 can determine the revised timestamp data 455 with improved accuracy using heuristic rules, such as improved accuracy for identifying the revised timestamp data 455g associated with the complex combination of token data 365g-365i, or the complex combination of token data 365e-365f.

In FIG. 4, the modified transcript data 425 indicates associations among particular portions of classification label data, revised text data, and revised timestamp data that correspond to a particular token element, such as a particular portion of token data from the token element data 365. For example, the modified transcript data 425 indicates an association of the portion of label data 457a, the portion of revised text data 445a, and the portion of revised timestamp data 455a, based on the correspondence of the portion of token data 365a with the data portions 457a, 445a, and 455a.

### Illustrative Methods

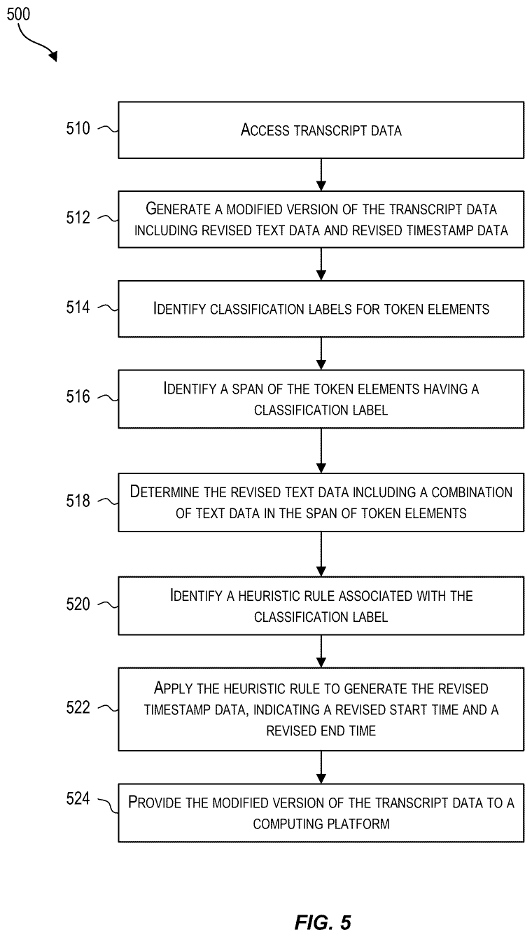

FIG. 5 is a process flow for generating revised timestamp data that is associated with transcript data, such as revised timestamp data that is based on complex combinations of token elements. The processing depicted in FIG. 5 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 5 and described below is intended to be illustrative and non-limiting. Although FIG. 5 depicts the various processing steps occurring in a particular sequence or order, this is not intended to be limiting. In certain alternative embodiments, the steps may be performed in some different order or some steps may also be performed in parallel. In certain embodiments, such as in the embodiment depicted in FIGS. 1-4, the processing depicted in FIG. 5 may be performed by a system (e.g., the ASR computing system 120 or the ASR computing system 220).

At block 510, transcript data is accessed by a computing system. In some cases, the computing system is an ASR computing system as described with respect to FIGS. 1-4. The transcript data comprises a set of one or more token elements, such as written token data elements or spoken token data elements. In some cases, each token element in the set includes text data, such as text data representing a portion of an audio recording. For example, each token element in the set of token elements could respective text data representing respective audio utterances, such as audio utterances converted to text data by applying automatic speech recognition techniques to the audio utterances recorded in audio data. In some cases, each token element in the set includes timestamp data, such as timestamp data representing a start time of the portion within the audio recording and an end time of the portion within the audio recording. For example, each token element in the set of token elements could respective timestamp data representing respective pairs of start and end times for the respective portions of audio data.

At block 512, a modified version of the transcript data is generated. The modified version of the transcript data includes one or more of revised text data or revised timestamp data. In some cases, generating the modified version of the transcript data includes removing, from the transcript data, one or more of text data or timestamp data, such as text data or timestamp data that are included in one or more token elements included in a span of token elements. In some cases, generating the modified version of the transcript data includes replacing, in the transcript data, one or more of the removed text data or timestamp data with one or more of revised text data or revised timestamp data. In some cases, the modified version of the transcript data is generated by one or more components of the ASR computing system, such as an ITN module or a timestamp revision module. In some implementations, operations related to block 512 can involve one or more additional operations described in FIG. 5, such as one or more operations related to blocks 514, 516, 518, 520, or 522.

At block 514, a set of one or more classification labels are identified for one or more of the token elements. For example, a classification label is identified for each token element in the set of token elements. In some cases, the classification labels are identified by one or more components of the ASR computing system, such as the ITN module or the timestamp revision module.

At block 516, one or more spans of token elements are identified from the set of token elements. In some cases, each token element in an identified span of token elements has a classification label from the set of classification labels. For example, each token element in a particular span of token elements could respectively have a particular classification label, such as an example “NUMERIC” classification label. In some cases, the classification labels indicate a correspondence to the particular classification label for each token element in the span. For example, a first token element having a first position in the set of token elements could have a first classification label and a second token element having a second position in the set of token elements could have a second classification label. In addition, the span of token elements is identified based on the first classification label and the second classification label indicating a particular classification type (e.g., a same type). In some cases, the first position in the set of token elements may, but need not be, an initial position in the set of token elements or in an identified span of token elements. In some cases, the second position in the set of token elements is subsequent to the first position. In some cases, the subsequent position of the second position may, but need not be, a position immediately following the first position. For example, an identified span of three token elements identified from the set may include the first token element having the first position, which is followed by an additional token element having an additional (e.g., interim) position, which is followed by the second token element having the second position. In some cases, one or more of the first classification label or the second classification label include flag data, such as a flag character indicating which of the first or second token elements (or additional token elements in the identified span) has a subsequent position to an initial position in the identified span. In some cases, the spans of token elements are identified by one or more components of the ASR computing system, such as the ITN module or the timestamp revision module.

At block 518, the revised text data is determined, such as the revised text data that is included in the modified version of the transcript data. In some cases, the revised text data is associated with a particular span of token elements. For example, the revised text data includes text data from each token element in the particular span of token elements, such as a combination of the text data from each token element in the particular span. In some cases, the revised text data is determined subsequent to identifying a correspondence of the classification label (e.g., such as described in regard to block 516) for each token element included in the particular span of token elements. In some cases, the revised text data is determined by one or more components of the ASR computing system, such as the ITN module or the timestamp revision module.

At block 520, one or more heuristic rules are identified, such as a heuristic rule that is associated with the classification label for each token element in an identified span of token elements. For example, a particular heuristic rule associated with the example “NUMERIC” classification label could be identified based on a determination that each token element in the particular span of token elements has the example “NUMERIC” classification label. In some cases, the heuristic rule is identified by one or more components of the ASR computing system, such as the ITN module or the timestamp revision module.

At block 522, the identified heuristic rule is applied for generating the revised timestamp data, such as the revised timestamp data that is included in the modified version of the transcript data. In some cases, the revised timestamp data is associated with a particular span of token elements, such as the same particular span of token elements associated with the revised text data (e.g., as described in regard to block 518). In some cases, the revised timestamp data indicates a revised start time and a revised end time of the revised text data. For example, applying the heuristic rule includes generating the revised timestamp data based on timestamp data from each token element in the particular span of token elements, such as a combination of the timestamp data from each token element in the particular span. In some cases, the identified heuristic rule is applied by one or more components of the ASR computing system, such as the ITN module or the timestamp revision module.

In some cases, generating the revised timestamp data includes determining respective timestamp data included in multiple token elements of a span of token elements, such as first timestamp data in a first token element and second timestamp data in a second token element. Based on determining that the span of token elements includes the first token element and the second token element, a heuristic rule library is accessed. In addition, the heuristic rule associated with the classification label is identified in the heuristic rule library. In some cases, the heuristic rule is applied to the respective timestamp data such as the first timestamp data and the second timestamp data.

At block 524, the modified version of the transcript data is provided to one or more additional computing platforms. For example the ASR computing system provides the modified version of the transcript data to an additional computing system (or other type of computing platform). The additional computing system is configured to generate one or more data outputs based on the modified version of the transcript data, such as closed captioning data output, subtitle data output, indexing data output, or other types of data outputs that are based on transcript data.

### Examples Of Cloud Infrastructure

The term cloud service is generally used to refer to a service that is made available by a cloud service provider (CSP) to users (e.g., cloud service customers) on demand (e.g., via a subscription model) using systems and infrastructure (cloud infrastructure) provided by the CSP. Typically, the servers and systems that make up the CSP's infrastructure are separate from the user's own on-premise servers and systems. Users can thus avail themselves of cloud services provided by the CSP without having to purchase separate hardware and software resources for the services. Cloud services are designed to provide a subscribing user easy, scalable access to applications and computing resources without the user having to invest in procuring the infrastructure that is used for providing the services.

There are several cloud service providers that offer various types of cloud services. As discussed herein, there are various types or models of cloud services including IaaS, software as a service (SaaS), platform as a service (PaaS), and others. A user can subscribe to one or more cloud services provided by a CSP. The user can be any entity such as an individual, an organization, an enterprise, and the like. When a user subscribes to or registers for a service provided by a CSP, a tenancy or an account is created for that user. The user can then, via this account, access the subscribed-to one or more cloud resources associated with the account.

As noted above, IaaS is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

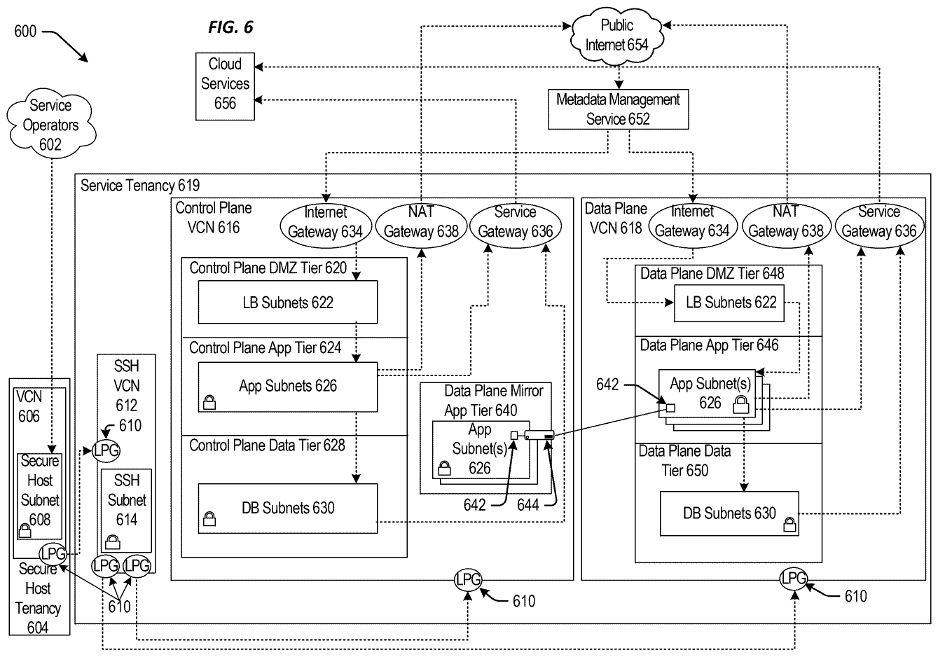

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 contained in the SSH VCN 612. The SSH VCN 612 can include an SSH subnet 614, and the SSH VCN 612 can be communicatively coupled to a control plane VCN 616 via the LPG 610 contained in the control plane VCN 616. Also, the SSH VCN 612 can be communicatively coupled to a data plane VCN 618 via an LPG 610. The control plane VCN 616 and the data plane VCN 618 can be contained in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 contained in the control plane DMZ tier 620 can be communicatively coupled to the app subnet(s) 626 contained in the control plane app tier 624 and an Internet gateway 634 that can be contained in the control plane VCN 616, and the app subnet(s) 626 can be communicatively coupled to the DB subnet(s) 630 contained in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 contained in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be contained in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively coupled to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way: the service gateway 636 can make API calls to cloud services 656, and cloud services 656 can send requested data to the service gateway 636. But, cloud services 656 may not initiate API calls to the service gateway 636.

In some examples, the secure host tenancy 604 can be directly connected to the service tenancy 619, which may be otherwise isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision desired resources. Desired resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be contained in the data plane mirror app tier 640 and the data plane app tier 646.

In some examples, users of the system, or customers, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 contained in the control plane DMZ tier 620. The LB subnet(s) 622 may determine that the request is valid, and in response to this determination, the LB subnet(s) 622 can transmit the request to app subnet(s) 626 contained in the control plane app tier 624. If the request is validated and requires a call to public Internet 654, the call to public Internet 654 may be transmitted to the NAT gateway 638 that can make the call to public Internet 654. Metadata that may be desired to be stored by the request can be stored in the DB subnet(s) 630.

In some examples, the data plane mirror app tier 640 can facilitate direct communication between the control plane VCN 616 and the data plane VCN 618. For example, changes, updates, or other suitable modifications to configuration may be desired to be applied to the resources contained in the data plane VCN 618. Via a VNIC 642, the control plane VCN 616 can directly communicate with, and can thereby execute the changes, updates, or other suitable modifications to configuration to, resources contained in the data plane VCN 618.

In some embodiments, the control plane VCN 616 and the data plane VCN 618 can be contained in the service tenancy 619. In this case, the user, or the customer, of the system may not own or operate either the control plane VCN 616 or the data plane VCN 618. Instead, the IaaS provider may own or operate the control plane VCN 616 and the data plane VCN 618, both of which may be contained in the service tenancy 619. This embodiment can enable isolation of networks that may prevent users or customers from interacting with other users', or other customers', resources. Also, this embodiment may allow users or customers of the system to store databases privately without needing to rely on public Internet 654, which may not have a desired level of threat prevention, for storage.

In other embodiments, the LB subnet(s) 622 contained in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may desire this embodiment since database(s) that the customers use may be controlled by the IaaS provider and may be stored on the service tenancy 619, which may be isolated from public Internet 654.

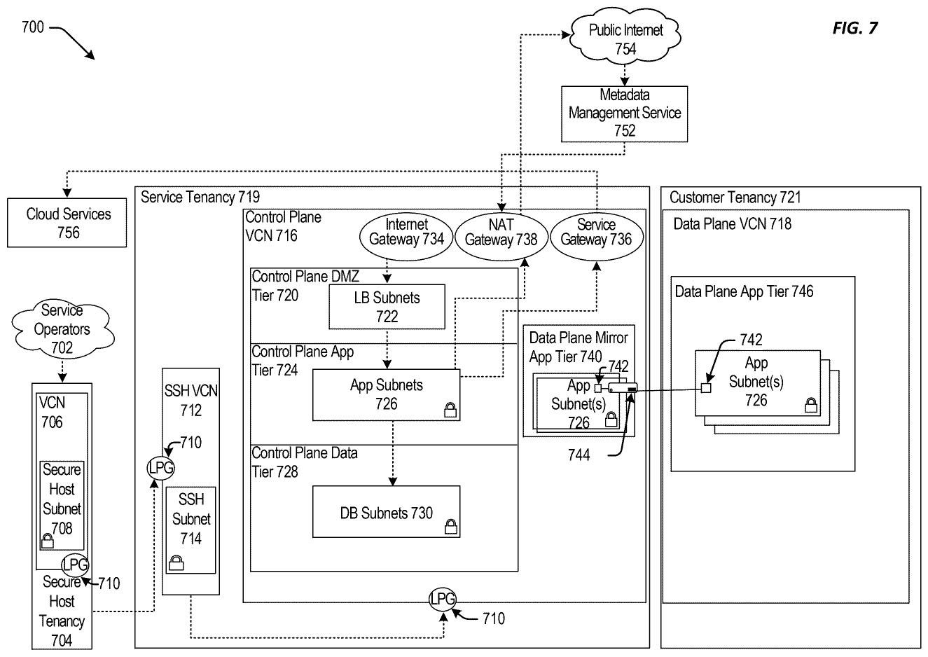

FIG. 7 is a block diagram 700 illustrating another example pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 606 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 710 contained in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 contained in the control plane VCN 716. The control plane VCN 716 can be contained in a service tenancy 719 (e.g., the service tenancy 619 of FIG. 6), and the data plane VCN 718 (e.g., the data plane VCN 618 of FIG. 6) can be contained in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), a control plane data tier 728 (e.g., the control plane data tier 628 of FIG. 6) that can include database (DB) subnet(s) 730 (e.g., similar to DB subnet(s) 630 of FIG. 6). The LB subnet(s) 722 contained in the control plane DMZ tier 720 can be communicatively coupled to the app subnet(s) 726 contained in the control plane app tier 724 and an Internet gateway 734 (e.g., the Internet gateway 634 of FIG. 6) that can be contained in the control plane VCN 716, and the app subnet(s) 726 can be communicatively coupled to the DB subnet(s) 730 contained in the control plane data tier 728 and a service gateway 736 (e.g., the service gateway 636 of FIG. 6) and a network address translation (NAT) gateway 738 (e.g., the NAT gateway 638 of FIG. 6). The control plane VCN 716 can include the service gateway 736 and the NAT gateway 738.

The control plane VCN 716 can include a data plane mirror app tier 740 (e.g., the data plane mirror app tier 640 of FIG. 6) that can include app subnet(s) 726. The app subnet(s) 726 contained in the data plane mirror app tier 740 can include a virtual network interface controller (VNIC) 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be contained in a data plane app tier 746 (e.g., the data plane app tier 646 of FIG. 6) via the VNIC 742 contained in the data plane mirror app tier 740 and the VNIC 742 contained in the data plane app tier 746.

The Internet gateway 734 contained in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 738 contained in the control plane VCN 716. The service gateway 736 contained in the control plane VCN 716 can be communicatively coupled to cloud services 756 (e.g., cloud services 656 of FIG. 6).

In some examples, the data plane VCN 718 can be contained in the customer tenancy 721. In this case, the IaaS provider may provide the control plane VCN 716 for each customer, and the IaaS provider may, for each customer, set up a unique compute instance 744 that is contained in the service tenancy 719. Each compute instance 744 may allow communication between the control plane VCN 716, contained in the service tenancy 719, and the data plane VCN 718 that is contained in the customer tenancy 721. The compute instance 744 may allow resources, that are provisioned in the control plane VCN 716 that is contained in the service tenancy 719, to be deployed or otherwise used in the data plane VCN 718 that is contained in the customer tenancy 721.

In other examples, the customer of the IaaS provider may have databases that live in the customer tenancy 721. In this example, the control plane VCN 716 can include the data plane mirror app tier 740 that can include app subnet(s) 726. The data plane mirror app tier 740 can reside in the data plane VCN 718, but the data plane mirror app tier 740 may not live in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity contained in the control plane VCN 716. The customer may desire to deploy or otherwise use resources in the data plane VCN 718 that are provisioned in the control plane VCN 716, and the data plane mirror app tier 740 can facilitate the desired deployment, or other usage of resources, of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, contained in the customer tenancy 721, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be live or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 7,” may be located in Region 1 and in “Region 2.” If a call to Deployment 7 is made by the service gateway 736 contained in the control plane VCN 716 located in Region 1, the call may be transmitted to Deployment 7 in Region 1. In this example, the control plane VCN 716, or Deployment 7 in Region 1, may not be communicatively coupled to, or otherwise in communication with, Deployment 7 in Region 2.

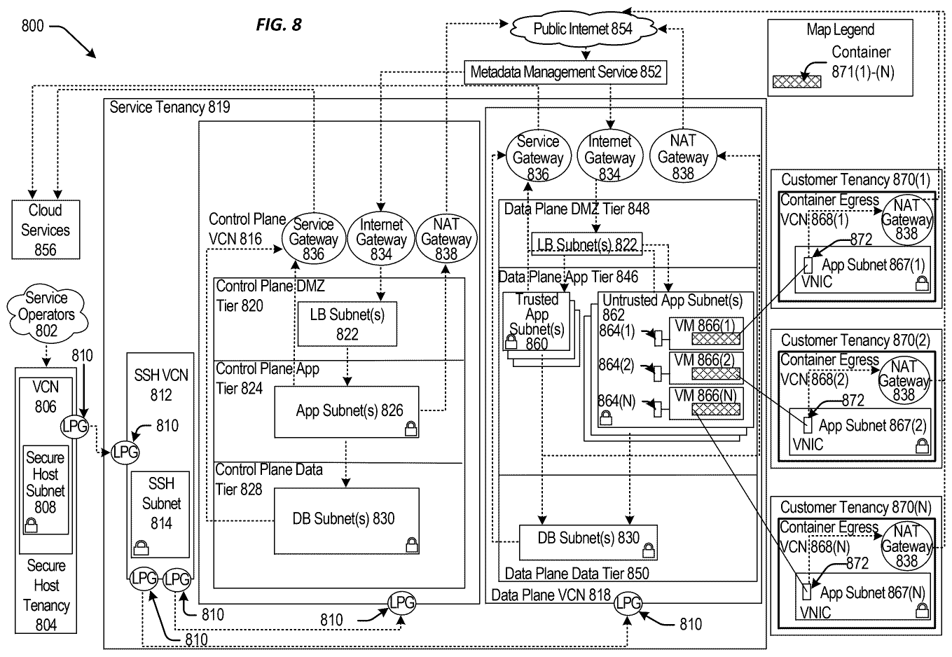

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 contained in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 contained in the control plane VCN 816 and to a data plane VCN 818 (e.g., the data plane 618 of FIG. 6) via an LPG 810 contained in the data plane VCN 818. The control plane VCN 816 and the data plane VCN 818 can be contained in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), a control plane data tier 828 (e.g., the control plane data tier 628 of FIG. 6) that can include DB subnet(s) 830. The LB subnet(s) 822 contained in the control plane DMZ tier 820 can be communicatively coupled to the app subnet(s) 826 contained in the control plane app tier 824 and to an Internet gateway 834 (e.g., the Internet gateway 634 of FIG. 6) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 6) and a network address translation (NAT) gateway 838 (e.g., the NAT gateway 638 of FIG. 6). The control plane VCN 816 can include the service gateway 836 and the NAT gateway 838.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860 and untrusted app subnet(s) 862 of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include one or more primary VNICs 864(1)-(N) that can be communicatively coupled to tenant virtual machines (VMs) 866(1)-(N). Each tenant VM 866(1)-(N) can be communicatively coupled to a respective app subnet 867(1)-(N) that can be contained in respective container egress VCNs 868(1)-(N) that can be contained in respective customer tenancies 870(1)-(N). Respective secondary VNICs 872(1)-(N) can facilitate communication between the untrusted app subnet(s) 862 contained in the data plane VCN 818 and the app subnet contained in the container egress VCNs 868(1)-(N). Each container egress VCNs 868(1)-(N) can include a NAT gateway 838 that can be communicatively coupled to public Internet 854 (e.g., public Internet 654 of FIG. 6).

The Internet gateway 834 contained in the control plane VCN 816 and contained in the data plane VCN 818 can be communicatively coupled to a metadata management service 852 (e.g., the metadata management service 652 of FIG. 6) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some embodiments, the data plane VCN 818 can be integrated with customer tenancies 870. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 846. Code to run the function may be executed in the VMs 866(1)-(N), and the code may not be configured to run anywhere else on the data plane VCN 818. Each VM 866(1)-(N) may be connected to one customer tenancy 870. Respective containers 871(1)-(N) contained in the VMs 866(1)-(N) may be configured to run the code. In this case, there can be a dual isolation (e.g., the containers 871(1)-(N) running code, where the containers 871(1)-(N) may be contained in at least the VM 866(1)-(N) that are contained in the untrusted app subnet(s) 862), which may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completion of running the code, the IaaS provider may kill or otherwise dispose of the containers 871(1)-(N).

In some embodiments, the trusted app subnet(s) 860 may run code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be contained in the VM 866(1)-(N) of each customer and that may run code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

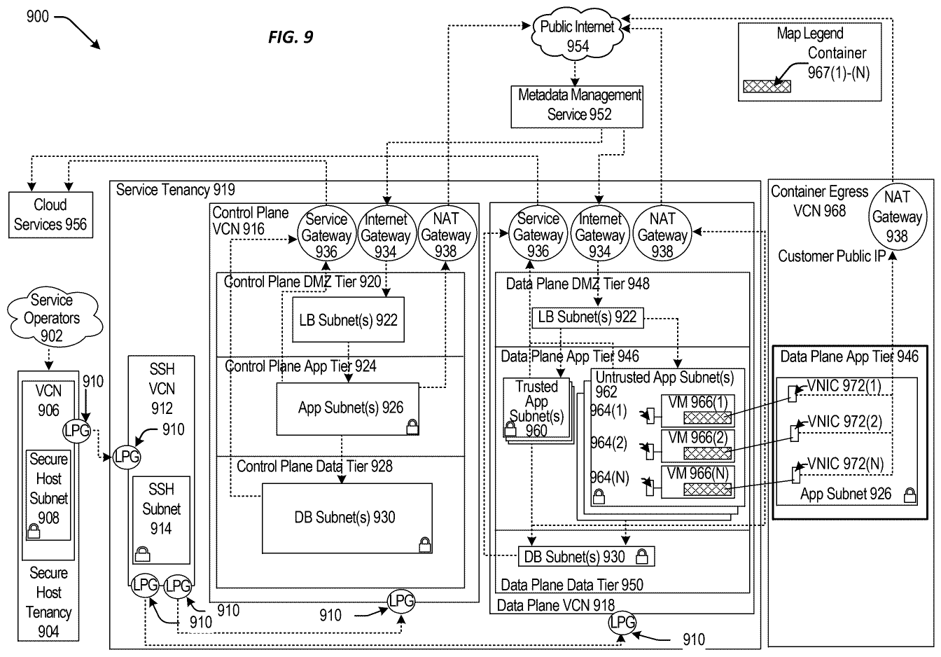

FIG. 9 is a block diagram 900 illustrating another example pattern of an IaaS architecture, according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 contained in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 contained in the control plane VCN 916 and to a data plane VCN 918 (e.g., the data plane 618 of FIG. 6) via an LPG 910 contained in the data plane VCN 918. The control plane VCN 916 and the data plane VCN 918 can be contained in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), a control plane data tier 928 (e.g., the control plane data tier 628 of FIG. 6) that can include DB subnet(s) 930 (e.g., DB subnet(s) 930 of FIG. 9). The LB subnet(s) 922 contained in the control plane DMZ tier 920 can be communicatively coupled to the app subnet(s) 926 contained in the control plane app tier 924 and to an Internet gateway 934 (e.g., the Internet gateway 634 of FIG. 6) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 6) and a network address translation (NAT) gateway 938 (e.g., the NAT gateway 638 of FIG. 6). The control plane VCN 916 can include the service gateway 936 and the NAT gateway 938.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 960 of FIG. 9) and untrusted app subnet(s) 962 (e.g., untrusted app subnet(s) 962 of FIG. 9) of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include primary VNICs 964(1)-(N) that can be communicatively coupled to tenant virtual machines (VMs) 966(1)-(N) residing within the untrusted app subnet(s) 962. Each tenant VM 966(1)-(N) can run code in a respective container 967(1)-(N), and be communicatively coupled to an app subnet 926 that can be contained in a data plane app tier 946 that can be contained in a container egress VCN 968. Respective secondary VNICs 972(1)-(N) can facilitate communication between the untrusted app subnet(s) 962 contained in the data plane VCN 918 and the app subnet contained in the container egress VCN 968. The container egress VCN can include a NAT gateway 938 that can be communicatively coupled to public Internet 954 (e.g., public Internet 654 of FIG. 6).

The Internet gateway 934 contained in the control plane VCN 916 and contained in the data plane VCN 918 can be communicatively coupled to a metadata management service 952 (e.g., the metadata management service 652 of FIG. 6) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some examples, the pattern illustrated by the architecture of block diagram 900 of FIG. 9 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 967(1)-(N) that are contained in the VMs 966(1)-(N) for each customer can be accessed in real-time by the customer. The containers 967(1)-(N) may be configured to make calls to respective secondary VNICs 972(1)-(N) contained in app subnet(s) 926 of the data plane app tier 946 that can be contained in the container egress VCN 968. The secondary VNICs 972(1)-(N) can transmit the calls to the NAT gateway 938 that may transmit the calls to public Internet 954. In this example, the containers 967(1)-(N) that can be accessed in real-time by the customer can be isolated from the control plane VCN 916 and can be isolated from other entities contained in the data plane VCN 918. The containers 967(1)-(N) may also be isolated from resources from other customers.

In other examples, the customer can use the containers 967(1)-(N) to call cloud services 956. In this example, the customer may run code in the containers 967(1)-(N) that requests a service from cloud services 956. The containers 967(1)-(N) can transmit this request to the secondary VNICs 972(1)-(N) that can transmit the request to the NAT gateway that can transmit the request to public Internet 954. Public Internet 954 can transmit the request to LB subnet(s) 922 contained in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, 900 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

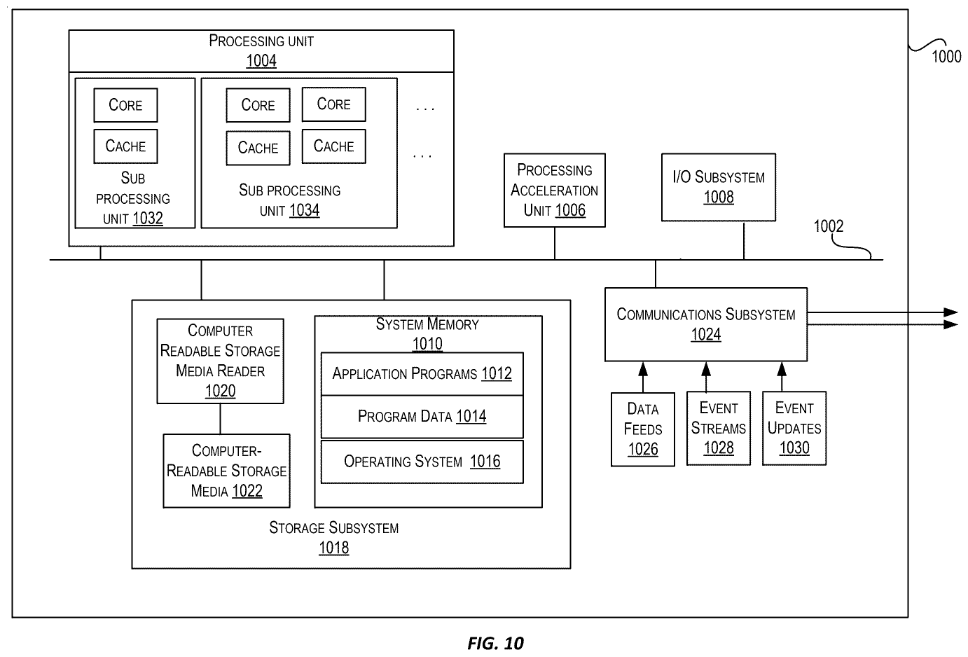

FIG. 10 illustrates an example computer system 1000, in which various embodiments may be implemented. The computer system 1000 may be used to implement any of the computer systems described above. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some, or all of the program code to be executed can be resident in processing unit(s) 1004 and/or in storage subsystem 1018. Through suitable programming, processing unit(s) 1004 can provide various functionalities described above. Computer system 1000 may additionally include a processing acceleration unit 1006, which can include a digital signal processor (DSP), a special-purpose processor, and/or the like.

I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1000 to a user or other computer. For example, user interface output devices may include, without limitation, a variety of display devices that visually convey text, graphics, and audio/video information such as monitors, printers, speakers, headphones, automotive navigation systems, plotters, voice output devices, and modems.

Computer system 1000 may comprise a storage subsystem 1018 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1004 provide the functionality described above. Storage subsystem 1018 may also provide a repository for storing data used in accordance with the present disclosure.

As depicted in the example in FIG. 10, storage subsystem 1018 can include various components including a system memory 1010, computer-readable storage media 1022, and a computer readable storage media reader 1020. System memory 1010 may store program instructions that are loadable and executable by processing unit 1004. System memory 1010 may also store data that is used during the execution of the instructions and/or data that is generated during the execution of the program instructions. Various different kinds of programs may be loaded into system memory 1010 including but not limited to client applications, Web browsers, mid-tier applications, relational database management systems (RDBMS), virtual machines, containers, etc.

System memory 1010 may also store an operating system 1016. Examples of operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1000 executes one or more virtual machines, the virtual machines along with their guest operating systems (GOSs) may be loaded into system memory 1010 and executed by one or more processors or cores of processing unit 1004.

System memory 1010 can come in different configurations depending upon the type of computer system 1000. For example, system memory 1010 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1010 may include a basic input/output system (BIOS) containing basic routines that help to transfer information between elements within computer system 1000, such as during start-up.

Computer-readable storage media 1022 may represent remote, local, fixed, and/or removable storage devices plus storage media for temporarily and/or more permanently containing, storing, computer-readable information for use by computer system 1000 including instructions executable by processing unit 1004 of computer system 1000.

Computer-readable storage media 1022 can include any appropriate media known or used in the art, including storage media and communication media, such as but not limited to, volatile and non-volatile, removable, and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Machine-readable instructions executable by one or more processors or cores of processing unit 1004 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments, communications subsystem 1024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.12 family standards, or other mobile communication technologies, or any combination thereof), global positioning system (GPS) receiver components, and/or other components. In some embodiments, communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

As used herein, when an action is “based on” something, this means the action is based at least in part on at least a part of the something. As used herein, the terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
accessing transcript data comprising a set of token elements, wherein each token element of the set of token elements comprises: (i) text data that represents a portion of a plurality of portions of an audio recording; and (ii) timestamp data that represents a start time of the portion within the audio recording and an end time of the portion within the audio recording;
generating a modified version of the transcript data, wherein the modified version of the transcript data includes revised text data and revised timestamp data and is generated by:
identifying a set of classification labels for the set of token elements;
identifying a span of token elements within the set of token elements, each token element in the span of token elements having a respective classification label within the set of classification labels;
subsequent to identifying a correspondence of the respective classification label for each token element in the span of token elements:
i) determining the revised text data, wherein the revised text data includes a combination of the text data comprised by each token element in the span of token elements,
ii) identifying a heuristic rule associated with the respective classification label for each token element in the span of token elements, and
iii) applying the heuristic rule to generate the revised timestamp data based on a combination of the timestamp data comprised by each token element in the span of token elements, wherein the revised timestamp data indicates a revised start time and a revised end time of the revised text data; and
providing the modified version of the transcript data to a computing platform for performing a computing operation using the modified version of the transcript data.

2. The computer-implemented method of claim 1, wherein generating the modified version of the transcript data further comprises:
removing, from the transcript data, the text data and the timestamp data comprised by each token element in the span of token elements;
replacing, in the transcript data, the text data with the revised text data; and
replacing, in the transcript data, the timestamp data with the revised timestamp data.

3. The computer-implemented method of claim 1, wherein identifying the correspondence of the respective classification label for each token element in the span of token elements comprises:
identifying, in the set of token elements, a first token element having a first position in the set of token elements and having a first classification label;
identifying, in the set of token elements, a second token element having a second position that is subsequent to the first token element in the set of token elements and having a second classification label, wherein the first classification label and the second classification label indicate a first classification type; and
based on the first classification label and the second classification label indicating the first classification type, identifying the span of token elements that includes the first token element and the second token element.

4. The computer-implemented method of claim 3, wherein the second classification label further indicates a sequential relationship with the first classification label.

5. The computer-implemented method of claim 4, wherein the sequential relationship is indicated by a flag character included in the second classification label.

6. The computer-implemented method of claim 1, wherein generating the revised timestamp data further comprises:
determining first respective timestamp data included in a first token element in the span of token elements and second respective timestamp data included in a second token element in the span of token elements;
based on determining that the span of token elements includes the first token element and the second token element, accessing a heuristic rule library;
identifying, in the heuristic rule library, the heuristic rule that is associated with the respective classification label; and
wherein applying the heuristic rule to generate the revised timestamp data comprises applying the heuristic rule to the first respective timestamp data and the second respective timestamp data.

7. The computer-implemented method of claim 1, wherein:
in the transcript data, the text data that represents the portion of the plurality of portions of the audio recording is generated based on automatic speech recognition applied to the audio recording, and
for each token element in the set of token elements, the start time and the end time are determined based on the automatic speech recognition applied to a converted audio utterance from the portion within the audio recording.

8. A system comprising:
one or more processing systems; and
one or more computer-readable media storing instructions which, when executed by the one or more processing systems, cause the system to perform operations comprising:
accessing transcript data comprising a set of token elements, wherein each token element of the set of token elements comprises: (i) text data that represents a portion of a plurality of portions of an audio recording; and (ii) timestamp data that represents a start time of the portion within the audio recording and an end time of the portion within the audio recording;
generating a modified version of the transcript data, wherein the modified version of the transcript data includes revised text data and revised timestamp data and is generated by:
identifying a set of classification labels for the set of token elements;
identifying a span of token elements within the set of token elements, each token element in the span of token elements having a respective classification label within the set of classification labels;
subsequent to identifying a correspondence of the respective classification label for each token element in the span of token elements:
i) determining the revised text data, wherein the revised text data includes a combination of the text data comprised by each token element in the span of token elements,
ii) identifying a heuristic rule associated with the respective classification label for each token element in the span of token elements, and
iii) applying the heuristic rule to generate the revised timestamp data based on a combination of the timestamp data comprised by each token element in the span of token elements, wherein the revised timestamp data indicates a revised start time and a revised end time of the revised text data; and
providing the modified version of the transcript data to a computing platform for performing a computing operation using the modified version of the transcript data.

9. The system of claim 8, the operations for generating the modified version of the transcript data further comprising:
removing, from the transcript data, the text data and the timestamp data comprised by each token element in the span of token elements;
replacing, in the transcript data, the text data with the revised text data; and
replacing, in the transcript data, the timestamp data with the revised timestamp data.

10. The system of claim 8, the operations for identifying the correspondence of the respective classification label for each token element in the span of token elements further comprising:
identifying, in the set of token elements, a first token element having a first position in the set of token elements and having a first classification label;
identifying, in the set of token elements, a second token element having a second position that is subsequent to the first token element in the set of token elements and having a second classification label, wherein the first classification label and the second classification label indicate a first classification type; and
based on the first classification label and the second classification label indicating the first classification type, identifying the span of token elements that includes the first token element and the second token element.

11. The system of claim 10, wherein the second classification label further indicates a sequential relationship with the first classification label.

12. The system of claim 11, wherein the sequential relationship is indicated by a flag character included in the second classification label.

13. The system of claim 8, the operations for determining the revised timestamp data further comprising:
determining first respective timestamp data included in a first token element in the span of token elements and second respective timestamp data included in a second token element in the span of token elements;
based on determining that the span of token elements includes the first token element and the second token element, accessing a heuristic rule library;
identifying, in the heuristic rule library, the heuristic rule that is associated with the respective classification label; and
wherein applying the heuristic rule to generate the revised timestamp data comprises applying the heuristic rule to the first respective timestamp data and the second respective timestamp data.

14. The system of claim 8, wherein:
in the transcript data, the text data that represents the portion of the plurality of portions of the audio recording is generated based on automatic speech recognition applied to the audio recording, and
for each token element in the set of token elements, the start time and the end time are determined based on the automatic speech recognition applied to a converted audio utterance from the portion within the audio recording.

15. One or more non-transitory computer-readable media storing instructions which, when executed by one or more processors, cause a system to perform operations comprising:
accessing transcript data comprising a set of token elements, wherein each token element of the set of token elements comprises: (i) text data that represents a portion of a plurality of portions of an audio recording; and (ii) timestamp data that represents a start time of the portion within the audio recording and an end time of the portion within the audio recording;
generating a modified version of the transcript data, wherein the modified version of the transcript data includes revised text data and revised timestamp data and is generated by:
identifying a set of classification labels for the set of token elements;
identifying a span of token elements within the set of token elements, each token element in the span of token elements having a respective classification label within the set of classification labels;
subsequent to identifying a correspondence of the respective classification label for each token element in the span of token elements:
i) determining the revised text data, wherein the revised text data includes a combination of the text data comprised by each token element in the span of token elements,
ii) identifying a heuristic rule associated with the respective classification label for each token element in the span of token elements, and
iii) applying the heuristic rule to generate the revised timestamp data based on a combination of the timestamp data comprised by each token element in the span of token elements, wherein the revised timestamp data indicates a revised start time and a revised end time of the revised text data; and
providing the modified version of the transcript data to a computing platform for performing a computing operation using the modified version of the transcript data.

16. The non-transitory computer-readable media of claim 15, wherein the operations for generating the modified version of the transcript data further comprise:
removing, from the transcript data, the text data and the timestamp data comprised by each token element in the span of token elements;
replacing, in the transcript data, the text data with the revised text data; and
replacing, in the transcript data, the timestamp data with the revised timestamp data.

17. The non-transitory computer-readable media of claim 15, wherein the operations for identifying the correspondence of the respective classification label for each token element in the span of token elements further comprise:
identifying, in the set of token elements, a first token element having a first position in the set of token elements and having a first classification label;
identifying, in the set of token elements, a second token element having a second position that is subsequent to the first token element in the set of token elements and having a second classification label, wherein the first classification label and the second classification label indicate a first classification type; and
based on the first classification label and the second classification label indicating the first classification type, identifying the span of token elements that includes the first token element and the second token element.

18. The non-transitory computer-readable media of claim 17, wherein the second classification label further indicates a sequential relationship with the first classification label.

19. The non-transitory computer-readable media of claim 15, wherein the operations for generating the revised timestamp data further comprise:
determining first respective timestamp data included in a first token element in the span of token elements and second respective timestamp data included in a second token element in the span of token elements;
based on determining that the span of token elements includes the first token element and the second token element, accessing a heuristic rule library;
identifying, in the heuristic rule library, the heuristic rule that is associated with the respective classification label; and
wherein applying the heuristic rule to generate the revised timestamp data comprises applying the heuristic rule to the first respective timestamp data and the second respective timestamp data.

20. The non-transitory computer-readable media of claim 15, wherein:
in the transcript data, the text data that represents the portion of the plurality of portions of the audio recording is generated based on automatic speech recognition applied to the audio recording, and
for each token element in the set of token elements, the start time and the end time are determined based on the automatic speech recognition applied to a converted audio utterance from the portion within the audio recording.
